(19) United States
(12) Patent Application Publication
(10) Pub. No.: US 2016/0072559 A1
(43) Pub. Date: Mar. 10, 2016

(54) METHOD, DEVICE AND SYSTEM FOR INTER-TERMINAL COORDINATED COMMUNICATION

(71) Applicant: HUAWEI TECHNOLOGIES CO.,LTD., Shenzhen (CN)

(72) Inventors: Dageng CHEN, Shanghai (CN); Jian LI, Shanghai (CN)

(73) Assignee: HUAWEI TECHNOLOGIES CO.,LTD., Shenzhen (CN)

(21) Appl. No.: 14/942,001

(22) Filed: Nov. 16, 2015

Related U.S. Application Data
(63) Continuation of application No. PCT/CN2014/077436, filed on May 14, 2014.

(30) Foreign Application Priority Data
May 14, 2013 (CN) 201310177773.2

(51) Int. Cl. H04B 7/02; H04J 11/00

(52) U.S. Cl. CPC H04B 7/024; H04J 11/0053; H04J 11/0056

(57) ABSTRACT

Embodiments of the present patent application disclose a method for inter-terminal coordinated communication, a device and a system. The present patent application relates to the field of communications, and inter-terminal coordinated transmission is accomplished by sharing specific information between coordinated terminals so as to improve performance of a system. The method provided by the embodiments of the present patent application includes: obtaining, by a first terminal, a shared signal according to a signal received by the first terminal from a network side; and sending, by the first terminal, shared information to a second terminal, for enabling the second terminal to obtain information that the network side needs to send to the second terminal according to the shared information and a signal received by the second terminal from the network side, where the shared information includes the shared signal.

### CROSS-REFERENCE TO RELATED APPLICATIONS

This application is a continuation of International Application No. PCT/CN2014/077436, filed on May 14, 2014, which claims priority to Chinese Patent Application No. 201310177773.2, filed on May 14, 2013, both of which are hereby incorporated by reference in their entireties.

### TECHNICAL FIELD

The present patent application relates to the field of communications, and in particular, to a method for inter-terminal coordinated communication, a device and a system.

### BACKGROUND

A coordinated multiple points transmission technology can improve a capability of covering a cell-edge user, further enhance a capacity of a wireless communication system, and particularly improve a transmission capability of an edge user, thereby becoming one of key technologies in a next generation of wireless communication system. A core idea of the coordinated multiple points transmission technology is to transmit information to a specific wireless terminal, or receive and process information from the specific wireless terminal by means of coordination of a plurality of geographically adjacent wireless transmission points. Coordinated multiple points transmission may be applied to a network side and may also be applied to a terminal side.

By means of inter-terminal coordinated transmission, system performance may be further improved and enhanced. For example, an available space dimension of the terminal side may be effectively improved, and a system capacity is improved; moreover, interference from an adjacent terminal may also be effectively suppressed, and a transmission quality is improved.

In prior art, an inter-terminal coordinated communication technology is generally achieved by the following method. Two base stations jointly process information needing to be sent and send the processed information to two terminals respectively. Under a certain signal to noise ratio condition, the two terminals respectively demodulate and decode respective received information and send the demodulated and decoded information to the other. The two terminals may complete demodulation of respective information only after completely demodulating and decoding information of the other terminal.

The inventor has found that the prior art at least has the following problems: the network side needs to jointly process a signal sent by the network side, which increases a complexity of information processing of the network side, and a terminal side needs to completely demodulate and decode information of other terminals, which increases a processing load of the terminal.

### SUMMARY

Embodiments of the present patent application provide a method, a device and a system for inter-terminal coordinated communication, which achieve inter-terminal coordinated transmission by sharing specific information between cooperative terminals so as to improve performance of a system.

To achieve the above-mentioned object, the embodiments of the present patent application adopt the following technical solutions.

In a first aspect, a method for inter-terminal coordinated communication is provided, including:

obtaining, by a first terminal, a shared signal according to a signal received by the first terminal from a network side; and

sending, by the first terminal, shared information to a second terminal, for enabling the second terminal to obtain information that the network side needs to send to the second terminal according to the shared information and a signal received by the second terminal from the network side, where the shared information includes the shared signal.

In a first possible implementation manner, according to the first aspect, the obtaining, by the first terminal, the shared signal according to the signal received by the first terminal from the network side, includes:

performing, by the first terminal, time domain sampling processing on the signal received by the first terminal from the network side to obtain the shared signal.

In a second possible implementation manner, according to the first aspect, the obtaining, by the first terminal, the shared signal according to the signal received by the first terminal from the network side, includes:

performing, by the first terminal, time domain sampling processing, cyclic prefix (CP) removal and time domain digital automatic gain control (DAGC) processing in turn on the signal received by the first terminal from the network side to obtain the shared signal; and

the shared information further includes a DAGC factor of the time domain DAGC processing performed by the first terminal on the signal received by the first terminal from the network side.

In a third possible implementation manner, according to the first aspect, the obtaining, by the first terminal, the shared signal according to the signal received by the first terminal from the network side, includes:

performing, by the first terminal, time domain sampling processing, CP removal, time domain DAGC, fast Fourier transform (FFT) and removal of information carried on a frequency domain resource of the first terminal in turn on the signal received by the first terminal from the network side to obtain the shared signal; and

the shared information further includes a DAGC factor of the time domain DAGC processing performed by the first terminal on the signal received by the first terminal from the network side and a serial number of a frequency domain resource corresponding to the shared signal.

In a fourth possible implementation manner, according to the first aspect, the obtaining, by the first terminal, the shared signal according to the signal received by the first terminal from the network side, includes:

performing, by the first terminal, time domain sampling processing, CP removal, time domain DAGC and fast Fourier transform (FFT) processing in turn on the signal received by the first terminal from the network side to obtain the shared signal; and

the shared information further includes a DAGC factor of the time domain DAGC processing performed by the first terminal on the signal received by the first terminal from the network side.

In a fifth possible implementation manner, in combination with the fourth possible implementation manner, the method further includes:

receiving, by the first terminal, identity information of the second terminal;

and, the obtaining, by the first terminal, the shared signal according to the signal received by the first terminal from the network side, further includes:

obtaining, by the first terminal, the shared signal according to the identity information of the second terminal, where the shared signal includes information carried on a frequency domain resource corresponding to the second terminal.

In a sixth possible implementation manner, in combination with the fifth possible implementation manner, after the obtaining, by the first terminal, the shared signal according to the signal received by the first terminal from the network side, the method further includes:

obtaining, by the first terminal, a signal quality of the shared signal; and

not sending, by the first terminal, the shared information to the second terminal, when the signal quality of the shared signal is less than a preset threshold.

In a seventh possible implementation manner, in combination with the sixth possible implementation manner, the method further includes:

sending, by the first terminal, the shared information to the second terminal, when the signal quality of the shared signal is greater than or equal to the preset threshold.

In a second aspect, another method for inter-terminal coordinated communication is provided, including:

receiving, by a second terminal, shared information sent by a first terminal, where the shared information includes a shared signal obtained by the first terminal according to a signal received by the first terminal from a network side; and

obtaining, by the second terminal, information that the network side needs to send to the second terminal according to the shared information and a signal received by the second terminal from the network side.

In a first possible implementation manner, according to the second aspect, the information that the network side needs to send to the second terminal includes information of the second terminal in the shared signal and information of the second terminal received by the second terminal.

In a second possible implementation manner, in combination with the second aspect or the first possible implementation manner, the shared signal is obtained by the first terminal after performing time domain sampling processing on the signal received by the first terminal from the network side;

and, the obtaining, by the second terminal, the information that the network side needs to send to the second terminal according to the shared information and the signal received by the second terminal from the network side, includes:

performing, by the second terminal, CP removal, time domain DAGC, fast Fourier transform (FFT), demodulating and decoding in turn on the shared signal to obtain information of the second terminal in the shared signal; and

performing, by the second terminal, time domain sampling processing, CP removal, time domain DAGC, FFT, demodulating and decoding in turn on the signal received by the second terminal from the network side to obtain information of the second terminal received by the second terminal.

In a third possible implementation manner, in combination with the second aspect or the first possible implementation manner, the shared signal is obtained by the first terminal after performing time domain sampling processing, CP removal and time domain DAGC processing in turn on the signal received by the first terminal from the network side;

and, the shared information further includes a DAGC factor of the time domain DAGC processing performed by the first terminal on the signal received by the first terminal from the network side;

and, the obtaining, by the second terminal, the information that the network side needs to send to the second terminal according to the shared information and the signal received by the second terminal from the network side, includes:

performing, by the second terminal, DAGC compensation processing on the shared signal according to the DAGC factor of the time domain DAGC processing performed on the signal received by the first terminal from the network side, and performing FFT, demodulating and decoding in turn on the processed shared signal to obtain information of the second terminal in the shared signal; and

performing, by the second terminal, time domain sampling processing, CP removal, time domain DAGC, FFT, demodulating and decoding in turn on the signal received by the second terminal from the network side to obtain information of the second terminal received by the second terminal.

In a fourth possible implementation manner, in combination with the second aspect or the first possible implementation manner, the shared signal is obtained by the first terminal after performing time domain sampling processing, CP removal, time domain DAGC, FFT and removal of information carried on a frequency domain resource of the first terminal in turn on the signal received by the first terminal from the network side;

and, the shared information further includes a DAGC factor of the time domain DAGC processing performed by the first terminal on the signal received by the first terminal from the network side and a serial number of a frequency domain resource corresponding to the shared signal;

and, the obtaining, by the second terminal, the information that the network side needs to send to the second terminal according to the shared information and the signal received by the second terminal from the network side, includes:

performing, by the second terminal, DAGC compensation processing on the shared signal according to the DAGC factor of the time domain DAGC processing performed on the signal received by the first terminal from the network side, and performing demodulating and decoding in turn on the processed shared signal according to the serial number of the frequency domain resource corresponding to the shared signal to obtain information of the second terminal in the shared signal; and

performing, by the second terminal, time domain sampling processing, CP removal, time domain DAGC, FFT, demodulating and decoding in turn on the signal received by the second terminal from the network side to obtain information of the second terminal received by the second terminal.

In a fifth possible implementation manner, in combination with the second aspect or the first possible implementation manner, the shared signal is obtained by the first terminal after performing time domain sampling processing, CP removal, time domain DAGC and FFT in turn on the signal received by the first terminal from the network side;

and, the shared information further includes a DAGC factor of the time domain DAGC processing performed by the first terminal on the signal received by the first terminal from the network side;

and, the obtaining, by the second terminal, the information that the network side needs to send to the second terminal according to the shared information and the signal received by the second terminal from the network side, includes:

obtaining, by the second terminal, information carried on a frequency domain resource of the second terminal according to a serial number of the frequency domain resource corresponding to the second terminal and allocated by a system, performing DAGC compensation processing on the information carried on the frequency domain resource of the second terminal according to the DAGC factor of the time domain DAGC processing performed on the signal received by the first terminal from the network side, and performing demodulating and decoding in turn on the processed information carried on the frequency domain resource of the second terminal to obtain information of the second terminal in the shared signal; and

performing, by the second terminal, time domain sampling processing, CP removal, time domain DAGC, FFT, demodulating and decoding in turn on the signal received by the second terminal from the network side to obtain information of the second terminal received by the second terminal.

In a sixth possible implementation manner, in combination with the second aspect or the first possible implementation manner, the method further includes:

sending, by the second terminal, identity information of the second terminal to the first terminal, so that the first terminal performs time domain sampling processing, CP removal, time domain DAGC and FFT in turn on the signal received by the first terminal from the network side, obtains the shared signal according to the identity information of the second terminal and obtains a signal quality of the shared signal; and does not send the shared information to the second terminal when the signal quality of the shared signal is less than a preset threshold, or sends the shared information to the second terminal when the signal quality of the shared signal is greater than or equal to the preset threshold, where the shared signal includes information carried on a frequency domain resource corresponding to the second terminal.

In the seventh possible implementation manner, in combination with the sixth possible implementation manner, the shared information further includes a DAGC factor of time domain DAGC processing performed by the first terminal on the signal received by the first terminal from the network side; and

the obtaining, by the second terminal, the information that the network side needs to send to the second terminal according to the shared information and the signal received by the second terminal from the network side, includes:

performing, by the second terminal, DAGC compensation processing on the shared signal according to the DAGC factor of the time domain DAGC processing performed on the signal received by the first terminal from the network side, and performing demodulating and decoding in turn on the processed shared signal to obtain information of the second terminal in the shared signal; and

performing, by the second terminal, time domain sampling processing, CP removal, time domain DAGC, FFT, demodulating and decoding in turn on the signal received by the second terminal from the network side to obtain information of the second terminal received by the second terminal.

In a third aspect, a first terminal is provided, including:

an obtaining unit, configured to obtain a shared signal according to a signal received by the first terminal from a network side, and transmit the shared signal to a sending unit; and

the sending unit, configured to send shared information to a second terminal, for enabling the second terminal to obtain information that the network side needs to send to the second terminal according to the shared information and a signal received by the second terminal from the network side, where the shared information includes the shared signal.

In a first possible implementation manner, according to the third aspect, the obtaining unit includes a time domain sampling processing module, configured to perform time domain sampling processing on the signal received by the first terminal from the network side to obtain the shared signal.

In a second possible implementation manner, according to the third aspect, the obtaining unit includes:

a time domain sampling processing module, configured to perform time domain sampling processing on the signal received by the first terminal from the network side;

a CP removing module, configured to remove a cyclic prefix (CP) from a signal processed by the time domain sampling processing module; and

a time domain DAGC module, configured to perform time domain digital automatic gain control (DAGC) processing on a signal processed by the CP removing module to obtain the shared signal; and

the shared information further includes a DAGC factor of the time domain DAGC processing performed by the first terminal on the signal received by the first terminal from the network side.

In a third possible implementation manner, according to the third aspect, the obtaining unit includes:

a time domain sampling processing module, configured to perform time domain sampling processing on the signal received by the first terminal from the network side;

a CP removing module, configured to remove a cyclic prefix (CP) from a signal processed by the time domain sampling processing module;

a time domain DAGC module, configured to perform time domain DAGC processing on a signal processed by the CP removing module; and

an FFT module, configured to perform fast Fourier transform (FFT) and removal of information carried on a frequency domain resource of the first terminal on a signal processed by the time domain DAGC module to obtain the shared signal; and

the shared information further includes a DAGC factor of the time domain DAGC processing performed by the first terminal on the signal received by the first terminal from the network side and a serial number of a frequency domain resource corresponding to the shared signal.

In a fourth possible implementation manner, in combination with the third possible implementation manner, the obtaining unit includes:

a time domain sampling processing module, configured to perform time domain sampling processing on the signal received by the first terminal from the network side;

a CP removing module, configured to remove a cyclic prefix (CP) from a signal processed by the time domain sampling processing module;

a time domain DAGC module, configured to perform time domain DAGC processing on a signal processed by the CP removing module; and

an FFT module, configured to perform FFT on a signal processed by the time domain DAGC module to obtain the shared signal; and

the shared information further includes a DAGC factor of the time domain DAGC processing performed by the first terminal on the signal received by the first terminal from the network side.

In a fifth possible implementation manner, in combination with the fourth possible implementation manner, the first terminal further includes: a receiving unit, configured to receive identity information of the second terminal and transmit the identity information of the second terminal to the obtaining unit;

and, the obtaining unit is further configured to obtain the shared signal according to the identity information of the second terminal, where the shared signal includes information carried on a frequency domain resource corresponding to the second terminal.

In a sixth possible implementation manner, in combination with the fifth possible implementation manner, the first terminal further includes: a signal quality obtaining unit, configured to obtain a signal quality of the shared signal; and

the sending unit is further configured to not send the shared information to the second terminal, when the signal quality of the shared signal is less than a preset threshold.

In a seventh possible implementation manner, in combination with the sixth possible implementation manner, the sending unit is further configured to: send the shared information to the second terminal, when the signal quality of the shared signal is greater than or equal to the preset threshold.

In a fourth aspect, a second terminal is provided, including:

a first receiving unit, configured to receive shared information sent by a first terminal and transmit the shared information to an obtaining unit, where the shared information includes a shared signal obtained by the first terminal according to a signal received by the first terminal from a network side;

a second receiving unit, configured to receive a signal from the network side and transmit the signal to the obtaining unit; and

the obtaining unit, configured to obtain information that the network side needs to send to the second terminal according to the shared information and the signal received by the second receiving unit from the network side.

In a first possible implementation manner, according to the fourth aspect, the information that the network side needs to send to the second terminal includes information of the second terminal in the shared signal and information of the second terminal received by the second receiving unit.

In a second possible implementation manner, in combination with the fourth aspect or the first possible implementation manner, the shared signal is obtained by the first terminal after performing time domain sampling processing on the signal received by the first terminal from the network side, and the obtaining unit includes:

a time domain sampling processing module, configured to perform time domain sampling processing on the signal received by the second receiving unit from the network side;

a CP removing module, configured to perform cyclic prefix (CP) removal processing on the shared signal and a signal processed by the time domain sampling processing module and received by the second receiving unit from the network side;

a time domain DAGC module, configured to perform time domain DAGC processing on a signal processed by the CP removing module;

an FFT module, configured to perform FFT processing on a signal processed by the time domain DAGC module;

a demodulating module, configured to demodulate a signal processed by the FFT module; and

a decoding module, configured to decode a signal processed by the demodulating module to obtain the information that the network side needs to send to the second terminal.

In a third possible implementation manner, in combination with the fourth aspect or the first possible implementation manner, the shared signal is obtained by the first terminal after performing time domain sampling processing, CP removal and time domain DAGC processing in turn on the signal received by the first terminal from the network side; the shared information further includes a DAGC factor of the time domain DAGC processing performed by the first terminal on the signal received by the first terminal from the network side; and

the obtaining unit includes:

a time domain sampling processing module, configured to perform time domain sampling processing on the signal received by the second receiving unit from the network side;

a CP removing module, configured to perform cyclic prefix (CP) removal processing on a signal processed by the time domain sampling processing module;

a time domain DAGC module, configured to perform DAGC compensation processing on the shared signal according to the DAGC factor of the time domain DAGC processing performed on the signal received by the first terminal from the network side, and perform time domain DAGC processing on a signal processed by the CP removing module;

an FFT module, configured to perform FFT processing on the shared signal and a signal processed by the time domain DAGC module;

a demodulating module, configured to demodulate a signal processed by the FFT module; and

a decoding module, configured to decode a signal processed by the demodulating module to obtain the information that the network side needs to send to the second terminal.

In a fourth possible implementation manner, in combination with the fourth aspect or the first possible implementation manner, the shared signal is obtained by the first terminal after performing time domain sampling processing, CP removal, time domain DAGC, FFT and removal of information carried on a frequency domain resource of the first terminal in turn on the signal received by the first terminal from the network side; the shared information further includes a DAGC factor of the time domain DAGC processing performed by the first terminal on the signal received by the first terminal from the network side and a serial number of a frequency domain resource corresponding to the shared signal; and

the obtaining unit includes:

a time domain sampling processing module, configured to perform time domain sampling processing on the signal received by the second receiving unit from the network side;

a CP removing module, configured to perform cyclic prefix (CP) removal processing on a signal processed by the time domain sampling processing module;

a time domain DAGC module, configured to perform DAGC compensation processing on the shared signal according to the DAGC factor of the time domain DAGC processing performed on the signal received by the first terminal from the network side, and perform time domain DAGC processing on a signal processed by the CP removing module;

an FFT module, configured to perform FFT processing on a signal processed by the time domain DAGC module;

a demodulating module, configured to demodulate a signal processed by the FFT module according to the serial number of the frequency domain resource corresponding to the shared signal; and

a decoding module, configured to decode a signal processed by the demodulating module to obtain the information that the network side needs to send to the second terminal.

In a fifth possible implementation manner, in combination with the fourth aspect or the first possible implementation manner, the shared signal is obtained by the first terminal after performing time domain sampling processing, CP removal, time domain DAGC and FFT in turn on the signal received by the first terminal from the network side; the shared information further includes a DAGC factor of the time domain DAGC processing performed by the first terminal on the signal received by the first terminal from the network side; and

the second terminal further includes:

a time domain sampling processing module, configured to perform time domain sampling processing on the signal received by the second receiving unit from the network side;

a CP removing module, configured to perform cyclic prefix (CP) removal processing on a signal processed by the time domain sampling processing module;

a time domain DAGC module, configured to perform DAGC compensation processing on the shared signal according to the DAGC factor of the time domain DAGC processing performed on the signal received by the first terminal from the network side, and perform time domain DAGC processing on a signal processed by the CP removing module;

an FFT module, configured to perform FFT processing on a signal processed by the time domain DAGC module;

a demodulating module, configured to demodulate a signal processed by the FFT module according to a serial number of a frequency domain resource corresponding to the second terminal and allocated by a system; and

a decoding module, configured to decode a signal processed by the demodulating module to obtain the information that the network side needs to send to the second terminal.

In a sixth possible implementation manner, in combination with the fourth aspect or the first possible implementation manner, the second terminal further includes:

a sending unit, configured to send identity information of the second terminal to the first terminal, so that the first terminal performs time domain sampling processing, CP removal, time domain DAGC and FFT in turn on the signal received by the first terminal from the network side, obtains the shared signal according to the identity information of the second terminal and obtains a signal quality of the shared signal; and does not send the shared information to the second terminal when the signal quality of the shared signal is less than a preset threshold, or sends the shared information to the second terminal when the signal quality of the shared signal is greater than or equal to the preset threshold, where the shared signal includes information carried on a frequency domain resource corresponding to the second terminal.

In the seventh possible implementation manner, in combination with the sixth possible implementation manner, the shared information further includes a DAGC factor of the time domain DAGC processing performed by the first terminal on the signal received by the first terminal from the network side; and

the obtaining unit includes:

a time domain sampling processing module, configured to perform time domain sampling processing on the signal received by the second receiving unit from the network side;

a CP removing module, configured to perform cyclic prefix (CP) removal processing on a signal processed by the time domain sampling processing module;

a time domain DAGC module, configured to perform DAGC compensation processing on the shared signal according to the DAGC factor of the time domain DAGC processing performed on the signal received by the first terminal from the network side, and perform time domain DAGC processing on a signal processed by the CP removing module;

an FFT module, configured to perform FFT processing on a signal processed by the time domain DAGC module;

a demodulating module, configured to demodulate a signal processed by the FFT module according to information carried on a frequency domain resource corresponding to the shared signal; and

a decoding module, configured to decode a signal processed by the demodulating module to obtain the information that the network side needs to send to the second terminal.

According to the method, the device and the system for inter-terminal coordinated communication provided by the embodiments of the present patent application, the first terminal obtains the shared signal according to the signal received by the first terminal from the network side. The first terminal sends the shared information to the second terminal, for enabling the second terminal to obtain the information that the network side needs to send to the second terminal according to the shared information and the signal received by the second terminal from the network side. The shared information includes the shared signal. Problems in the prior art that the network side needs to jointly process a signal sent by the network side which increases a complexity of information processing of the network side, and that a terminal needs to completely demodulate information of other terminals which increases a processing load of the terminal are overcome.

### BRIEF DESCRIPTION OF DRAWINGS

To illustrate technical solutions in embodiments of the present patent application or in the prior art more clearly, a brief introduction on the accompanying drawings which are needed in the description of the embodiments or the prior art is given below. Apparently, the accompanying drawings in the description below are merely some of the embodiments of the present patent application, based on which other drawings may be obtained by those of ordinary skill in the art without any creative effort.

FIG. 1 is a flow chart of a method for coordinated communication of a first terminal side provided by an embodiment of the present patent application;

FIG. 2 is a flow chart of a method for coordinated communication of a second terminal side provided by an embodiment of the present patent application;

FIG. 3 is a schematic diagram of an application scenario provided by an embodiment of the present patent application;

FIG. 4 is a schematic diagram of another application scenario provided by an embodiment of the present patent application;

FIG. 5 is a flow chart of a method for inter-terminal coordinated communication provided by an embodiment of the present patent application;

FIG. 6 is a flow chart of another method for inter-terminal coordinated communication provided by an embodiment of the present patent application;

FIG. 7 is a flow chart of another method for inter-terminal coordinated communication provided by an embodiment of the present patent application;

FIG. 8 is a schematic diagram of information carried on a frequency domain resource of a first terminal side provided by an embodiment of the present patent application;

FIG. 9 is a flow chart of another method for inter-terminal coordinated communication provided by an embodiment of the present patent application;

FIG. 10 is a schematic diagram of another information carried on a frequency domain resource of a first terminal side provided by an embodiment of the present patent application;

FIG. 11 is a flow chart of another method for inter-terminal coordinated communication provided by an embodiment of the present patent application;

FIG. 12 is a schematic diagram of another information carried on a frequency domain resource of a first terminal side provided by an embodiment of the present patent application;

FIG. 13 is a schematic diagram of another information carried on a frequency domain resource of a first terminal side provided by an embodiment of the present patent application;

FIG. 14 is a schematic diagram of another information carried on a frequency domain resource of a first terminal side provided by an embodiment of the present patent application;

FIG. 15 is an apparatus schematic diagram of a first terminal provided by an embodiment of the present patent application;

FIG. 16 is an apparatus schematic diagram of another first terminal provided by an embodiment of the present patent application;

FIG. 17 is an apparatus schematic diagram of another first terminal provided by an embodiment of the present patent application;

FIG. 18 is an apparatus schematic diagram of another first terminal provided by an embodiment of the present patent application;

FIG. 19 is an apparatus schematic diagram of a second terminal provided by an embodiment of the present patent application;

FIG. 20 is an apparatus schematic diagram of another second terminal provided by an embodiment of the present patent application;

FIG. 21 is an apparatus schematic diagram of a first terminal provided by an embodiment of the present patent application;

FIG. 22 is an apparatus schematic diagram of a second terminal provided by an embodiment of the present patent application.

### DETAILED DESCRIPTION

A clear and complete description of technical solutions in embodiments of the present patent application will be given below, in combination with the accompanying drawings in the embodiments of the present patent application. Apparently, the embodiments described below are merely a part, but not all, of the embodiments of the present patent application. All of the other embodiments, obtained by those of ordinary skill in the art based on the embodiments of the present patent application without any creative effort, fall into the protection scope of the present patent application.

It should be understood that, the technical solutions of the embodiments of the present patent application may be applied to various communication systems, for example: a long term evolution (LTE) system, an LTE frequency division duplex (FDD) system, an LTE time division duplex (TDD), a worldwide interoperability for microwave access (WiMAX) communication system or the like.

The embodiments of the present patent application respectively illustrate from a first terminal side and a second terminal side and illustrate an interactive embodiment of the two. But it does not mean that the two must be interactively implemented. In fact, when a first terminal and a second terminal are separately implemented, problems respectively existing on the first terminal side and the second terminal side are solved as well. It is just that when the two are cooperatively used, a better technical effect will be obtained.

FIG. 1 is a flow chart of a method for coordinated communication of a first terminal side. Referring to the figure, the method may include the following steps.

101: A first terminal obtains a shared signal according to a signal received by the first terminal from a network side.

Exemplarily, the network side in the embodiment of the present patent application may refer to a sending terminal of a signal received by the first terminal and a second terminal from a space. For example, the network side may be one base station or two base stations, and may also be a plurality of base stations.

Exemplarily, the first terminal may obtain the shared signal according to the signal received by the first terminal from the network side in any one of the following manners.

1. The first terminal performs time domain sampling processing on the signal received by the first terminal from the network side to obtain the shared signal.

2. The first terminal performs time domain sampling processing, cyclic prefix (CP) removal and time domain digital automatic gain control (DAGC) processing in turn on the signal received by the first terminal from the network side to obtain the shared signal.

3. The first terminal performs time domain sampling processing, CP removal, time domain DAGC, fast Fourier transform (FFT) and removal of information carried on a frequency domain resource of the first terminal in turn on the signal received by the first terminal from the network side to obtain the shared signal.

4. The first terminal performs time domain sampling processing, CP removal, time domain DAGC and fast Fourier transform (FFT) processing in turn on the signal received by the first terminal from the network side to obtain the shared signal.

5. Exemplarily, the method may further include:

the first terminal receives identity information of the second terminal; and

based on 4, the first terminal obtains the shared signal according to the identity information of the second terminal, where the shared signal includes information carried on a frequency domain resource corresponding to the second terminal.

Exemplarily, according to the above-mentioned manner 4, after the first terminal obtains the shared signal according to the signal received by the first terminal from the network side, the method may further include:

obtaining, by the first terminal, a signal quality of the shared signal; and

not sending, by the first terminal, the shared information to the second terminal, when the signal quality of the shared signal is less than a preset threshold;

or,

sending, by the first terminal, the shared information to the second terminal, when the signal quality of the shared signal is greater than or equal to the preset threshold.

102: The first terminal sends shared information to the second terminal, for enabling the second terminal to obtain information that the network side needs to send to the second terminal according to the shared information and a signal received by the second terminal from the network side, where the shared information includes the shared signal.

Exemplarily, the first terminal may send the shared information to the second terminal in a direct communication mode, as long as the first terminal and the second terminal may directly communicate geographically. The direct communication mode of the first terminal and the second terminal is not limited in the embodiment of the present patent application. For example, it may be short-range communication modes, such as WiFi, a near field communication or the like.

Exemplarily, since the manners of obtaining the shared signal according to the signal received by the first terminal from the network side are different, contents of the shared information are also different. For example,

When the first terminal adopts the above-mentioned manner 1 to obtain the shared signal, the shared information may only include the shared signal.

When the first terminal adopts the above-mentioned manner 2, 4 or 5 to obtain the shared signal, the shared information may include the shared signal and a DAGC factor of the time domain DAGC processing performed by the first terminal on the signal received by the first terminal from the network side.

When the first terminal adopts the above-mentioned manner 3 to obtain the shared signal, the shared information may include the shared signal, a DAGC factor of the time domain DAGC processing performed by the first terminal on the signal received by the first terminal from the network side and a serial number of a frequency domain resource corresponding to the shared signal.

According to the method for inter-terminal coordinated communication provided by the embodiment of the present patent application, the first terminal obtains the shared signal according to the signal received by the first terminal from the network side. The first terminal sends the shared information to the second terminal, for enabling the second terminal to obtain the information that the network side needs to send to the second terminal according to the shared information and the signal received by the second terminal from the network side. The shared information includes the shared signal. Problems in the prior art that the network side needs to jointly process a signal sent by the network side which increases a complexity of information processing of the network side, and that a terminal needs to completely demodulate information of other terminals which increases a processing load of the terminal are overcome.

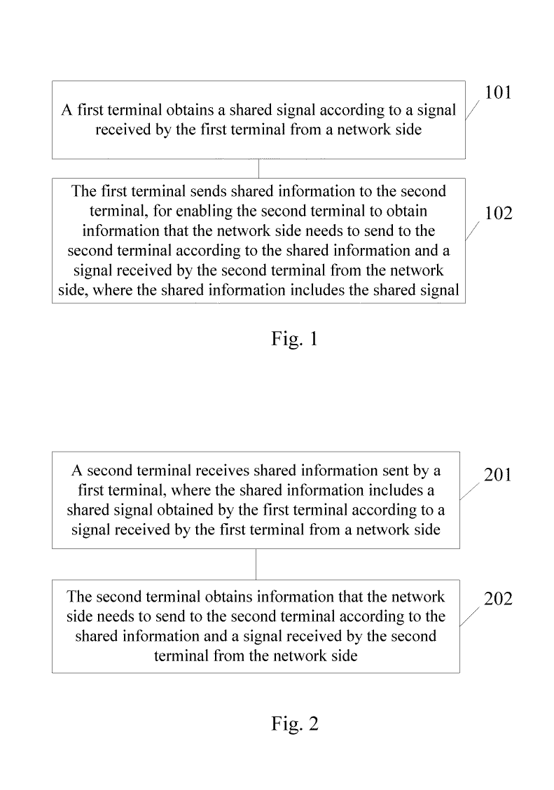

FIG. 2 is a flow chart of a method for coordinated communication of a second terminal side. Referring to the figure, the method may include the following steps.

201: A second terminal receives shared information sent by a first terminal, where the shared information includes a shared signal obtained by the first terminal according to a signal received by the first terminal from a network side.

Exemplarily, the network side in the embodiment of the present patent application may refer to a sending terminal of a signal received by the first terminal and the second terminal from a space. For example, the network side may be one base station or two base stations, and may also be a plurality of base stations.

Exemplarily, the second terminal may receive the shared information sent by the first terminal in a direct communication mode, as long as the first terminal and the second terminal may directly communicate geographically. The direct communication mode of the first terminal and the second terminal is not limited in the embodiment of the present patent application. For example, it may be short-range communication modes, such as WiFi, a near field communication or the like.

Exemplarily, the first terminal may obtain the shared signal according to the signal received by the first terminal from the network side in any one of the following manners.

1. The first terminal performs time domain sampling processing on the signal received by the first terminal from the network side to obtain the shared signal.

2. The first terminal performs time domain sampling processing, cyclic prefix (CP) removal and time domain digital automatic gain control (DAGC) processing in turn on the signal received by the first terminal from the network side to obtain the shared signal.

3. The first terminal performs time domain sampling processing, CP removal, time domain DAGC, fast Fourier transform (FFT) and removal of information carried on a frequency domain resource of the first terminal in turn on the signal received by the first terminal from the network side to obtain the shared signal.

4. The first terminal performs time domain sampling processing, CP removal, time domain DAGC and fast Fourier transform (FFT) processing in turn on the signal received by the first terminal from the network side to obtain the shared signal.

5. Exemplarily, the method may further include:

the second terminal sends identity information of the second terminal to the first terminal, so that based on 4, the first terminal obtains the shared signal according to the identity information of the second terminal, where the shared signal includes information carried on a frequency domain resource corresponding to the second terminal;

and the first terminal obtains a signal quality of the shared signal;

and the first terminal does not send the shared information to the second terminal, when the signal quality of the shared signal is less than a preset threshold;

or,

the first terminal sends the shared information to the second terminal, when the signal quality of the shared signal is greater than or equal to the preset threshold.

Exemplarily, since the manners of obtaining the shared signal according to the signal received by the first terminal from the network side are different, contents of the shared information are also different. For example,

1. When the first terminal adopts the above-mentioned manner 1 to obtain the shared signal, the shared information may only include the shared signal.

2. When the first terminal adopts the above-mentioned manner 2, 4 or 5 to obtain the shared signal, the shared information may include the shared signal and a DAGC factor of the time domain DAGC processing performed by the first terminal on the signal received by the first terminal from the network side.

3. When the first terminal adopts the above-mentioned manner 3 to obtain the shared signal, the shared information may include the shared signal, a DAGC factor of the time domain DAGC processing performed by the first terminal on the signal received by the first terminal from the network side and a serial number of a frequency domain resource corresponding to the shared signal.

202: The second terminal obtains information that the network side needs to send to the second terminal according to the shared information and a signal received by the second terminal from the network side.

Exemplarily, according to different manners of obtaining the shared signal according to the signal received by the first terminal from the network side and different shared information, manners in which the second terminal obtains the information that the network side needs to send to the second terminal according to the shared information and the signal received by the second terminal from the network side are different. For example:

1. When the first terminal adopts the above-mentioned manner 1 to obtain the shared signal, and the shared information includes the shared signal, obtaining, by the second terminal, the information that the network side needs to send to the second terminal according to the shared information and the signal received by the second terminal from the network side, may include:

performing, by the second terminal, CP removal, time domain DAGC, fast Fourier transform FFT, demodulating and decoding in turn on the shared signal to obtain information of the second terminal in the shared signal; and

performing, by the second terminal, time domain sampling processing, CP removal, time domain DAGC, FFT, demodulating and decoding in turn on the signal received by the second terminal from the network side to obtain information of the second terminal received by the second terminal.

2. When the first terminal adopts the above-mentioned manner 2 to obtain the shared signal, and the shared information includes the shared signal and the DAGC factor of the time domain DAGC processing performed by the first terminal on the signal received by the first terminal from the network side, obtaining, by the second terminal, the information that the network side needs to send to the second terminal according to the shared information and the signal received by the second terminal from the network side, may include:

performing, by the second terminal, DAGC compensation processing on the shared signal according to the DAGC factor of the time domain DAGC processing performed on the signal received by the first terminal from the network side, and performing FFT, demodulating and decoding in turn on the processed shared signal to obtain the information of the second terminal in the shared signal; and

performing, by the second terminal, time domain sampling processing, CP removal, time domain DAGC, FFT, demodulating and decoding in turn on the signal received by the second terminal from the network side to obtain information of the second terminal received by the second terminal.

3. When the first terminal adopts the above-mentioned manner 3 to obtain the shared signal, and the shared information includes the shared signal, the DAGC factor of the time domain DAGC processing performed by the first terminal on the signal received by the first terminal from the network side and the serial number of the frequency domain resource corresponding to the shared signal, obtaining, by the second terminal, the information that the network side needs to send to the second terminal according to the shared information and the signal received by the second terminal from the network side, may include:

performing, by the second terminal, DAGC compensation processing on the shared signal according to the DAGC factor of the time domain DAGC processing performed on the signal received by the first terminal from the network side, and performing demodulating and decoding in turn on the processed shared signal according to the serial number of the frequency domain resource corresponding to the shared signal to obtain information of the second terminal in the shared signal; and

performing, by the second terminal, time domain sampling processing, CP removal, time domain DAGC, FFT, demodulating and decoding in turn on the signal received by the second terminal from the network side to obtain information of the second terminal received by the second terminal.

4. When the first terminal adopts the above-mentioned manner 4 to obtain the shared signal, and the shared information includes the shared signal and the DAGC factor of the time domain DAGC processing performed by the first terminal on the signal received by the first terminal from the network side, obtaining, by the second terminal, the information that the network side needs to send to the second terminal according to the shared information and the signal received by the second terminal from the network side, may include:

obtaining, by the second terminal, information carried on a frequency domain resource of the second terminal according to a serial number of the frequency domain resource corresponding to the second terminal and allocated by a system, performing DAGC compensation processing on the information carried on the frequency domain resource of the second terminal according to the DAGC factor of the time domain DAGC processing performed on the signal received by the first terminal from the network side, and performing demodulating and decoding in turn on the processed information carried on the frequency domain resource of the second terminal to obtain information of the second terminal in the shared signal; and

performing, by the second terminal, time domain sampling processing, CP removal, time domain DAGC, FFT, demodulating and decoding in turn on the signal received by the second terminal from the network side to obtain information of the second terminal received by the second terminal.

5. When the first terminal adopts the above-mentioned manner 5 to obtain the shared signal, and the shared information includes the shared signal and the DAGC factor of the time domain DAGC processing performed by the first terminal on the signal received by the first terminal from the network side, obtaining, by the second terminal, the information that the network side needs to send to the second terminal according to the shared information and the signal received by the second terminal from the network side, includes:

performing, by the second terminal, DAGC compensation processing on the shared signal according to the DAGC factor of the time domain DAGC processing performed on the signal received by the first terminal from the network side, and performing demodulating and decoding in turn on the processed shared signal to obtain information of the second terminal in the shared signal; and

performing, by the second terminal, time domain sampling processing, CP removal, time domain DAGC, FFT, demodulating and decoding in turn on the signal received by the second terminal from the network side to obtain information of the second terminal received by the second terminal.

According to the method for inter-terminal coordinated communication provided by the embodiment of the present patent application, the second terminal receives the shared information sent by the first terminal and obtains the information that the network side needs to send to the second terminal according to the shared information and the signal received by the second terminal from the network side. Problems in the prior art that the network side needs to jointly process a signal sent by the network side and a terminal needs to completely demodulate information of other terminals which increase a complexity of information processing of the network side and a processing load of the terminal are overcome.

The above-mentioned method embodiments will be illustrated below by specific embodiments.

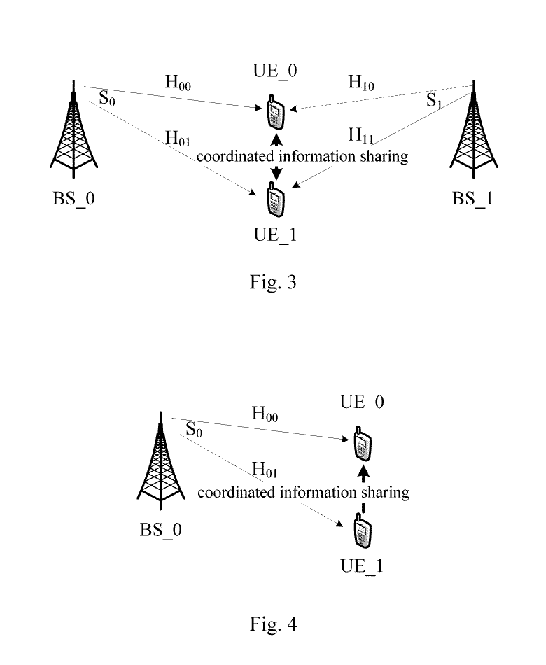

Exemplarily, two application scenarios are set in the embodiments of the present patent application, and the following specific embodiments will be respectively illustrated in the two application scenarios. FIG. 3 illustrates a first application scenario. The application scenario includes a first base station, a second base station, a first terminal and a second terminal. In the embodiments of the present patent application, the first base station is marked as BS_1, the second base station is marked as BS_0, the first terminal is marked as UE_1 and the second terminal is marked as UE_0, where the first base station BS_1 needs to send information to the first terminal UE_1, and the second base station BS_0 needs to send information to the second terminal UE_0. FIG. 4 illustrates a second application scenario. The application scenario includes a second base station BS_0, a first terminal UE_1 and a second terminal UE_0, where the second base station BS_0 needs to send information to the second terminal UE_0.

### Embodiment 1

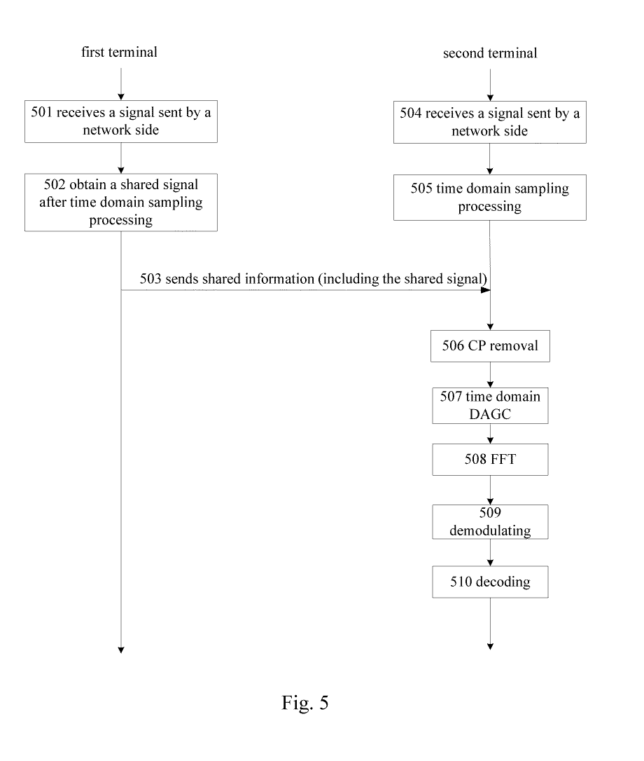

The above-mentioned first application scenario is selected for illustration in the embodiment, referring to FIG. 5, including:

S501: a first terminal receives a signal sent by a network side.

Exemplarily, since a wireless signal is propagated in a space, the first terminal UE_1 may receive both a signal sent by the first base station BS_1 and a signal sent by the second base station BS_0.

Exemplarily, the signal received by the first terminal UE_1 may be expressed by the following formula:

Y₁=H₁₁·S₁+H₀₁·S₀+N₁,

where Y₁ expresses the signal received by the first terminal UE_1, H₁₁ expresses a space channel between the first base station BS_1 and the first terminal UE_1, H₀₁ expresses a space channel between the second base station BS_0 and the first terminal UE_1, S₁ and S₀ respectively express information sent by the first base station BS_1 and the second base station BS_0, and N₁ expresses a noise signal received by the first terminal UE_1.

For the first terminal UE_1, H₀₁·S₀ is an interference signal, but for the second terminal UE_0, H₀₁·S₀ is a useful signal. Thus, if the first terminal UE_1 shares the formula with the second terminal UE_0, the second terminal UE_0 may improve demodulation performance for S0.

S502: the first terminal performs time domain sampling processing on the signal received by the first terminal from the network side to obtain a shared signal.

S503: the first terminal sends shared information to the second terminal, where the shared information includes the shared signal.

S504: the second terminal receives a signal sent by the network side.

Since a wireless signal is propagated in a space, the second terminal UE_0 may receive both a signal sent by the first base station BS_1 and a signal sent by the second base station BS_0,

the signal received by the second terminal UE_0 may be described by the following formula:

Y₀=H₀₀·S₀+H₁₀·S₁+N₀,

where Y₀ expresses the signal received by the second terminal UE_0, H₀₀ expresses a space channel between the second base station and the second terminal, H₁₀ expresses a space channel between the first base station and the second terminal, and N₀ expresses a noise signal received by the second terminal UE_0.

S505: the second terminal performs time domain sampling processing on the signal received by the second terminal from the network side.

S506: the second terminal performs CP removal processing on the shared signal and the signal received by the second terminal from the network side.

S507: the second terminal performs time domain DAGC processing on the shared signal with CP removed and the signal, with CP removed, received by the second terminal from the network side.

S508: the second terminal performs FFT processing on the shared signal after the time domain DAGC processing and the signal received by the second terminal from the network side after the time domain DAGC processing.

S509: the second terminal demodulates the shared signal after the FFT processing and the signal received by the second terminal from the network side after the FFT processing.

Exemplarily, the second terminal may obtain information of H₀₁ by channel estimation in demodulating process of itself, such that the second terminal obtains information that the network side needs to send to the second terminal according to H₀₁.

S510: the second terminal decodes the demodulated shared signal and the demodulated signal received by the second terminal from the network side.

For example, the second terminal UE_0 obtains the following receiving signal according to obtained channel information:

$$Y = [ \begin{matrix}{Y}_{0} \\ {Y}_{1}\end{matrix} ] = [ \begin{matrix}{H}_{00} \\ {H}_{01}\end{matrix} ] \cdot {S}_{0} + [ \begin{matrix}{H}_{10} \\ {H}_{11}\end{matrix} ] \cdot {S}_{1} + [ \begin{matrix}{N}_{0} \\ {N}_{1}\end{matrix} ] .$$

According to a receiver W₀ adopted by the second terminal UE_0, an estimated value of S0 sent by the second base station BS_0 may be obtained:

Ŝ₀=W₀·Y.

The second terminal UE_0 demodulates Ŝ₀ via [H₀₀ H₀₁]^{T} to achieve sharing of the first terminal UE_1, thereby improving a quality of the received signal of the second terminal UE_0.

According to the method for inter-terminal coordinated communication provided by the embodiment of the present patent application, the second terminal receives the shared information sent by the first terminal and obtains the information that the network side needs to send to the second terminal according to the shared information and the signal received by the second terminal from the network side. Problems in the prior art that the network side needs to jointly process a signal sent by the network side which increases a complexity of information processing of the network side, and that a terminal needs to completely demodulate information of other terminals which increases a processing load of the terminal are overcome.

### Embodiment 2

The above-mentioned second application scenario is selected for illustration in the embodiment. Steps and a principle of the embodiment are same as those of embodiment 1. A difference is that signals received by the first terminal UE_1 and the second terminal UE_0 from the network side are different, and only the difference is illustrated herein.

In the second application scenario, since a wireless signal is propagated in a space, the first terminal UE_1 may receive a signal sent by the second base station BS_0.

Exemplarily, the signal received by the first terminal UE_1 may be expressed by the following formula:

Y₁=H₀₁·S₀+N₁,

where Y₁ expresses the signal received by the first terminal UE_1, H₀₁ expresses a space channel between the second base station and the first terminal, S₀ expresses information sent by the second base station, and N₁ expresses a noise signal received by the first terminal UE_1.

The signal received by the second terminal UE_0 may be described by the following formula:

Y₀=H₀₀·S₀+N₀,

where Y₀ expresses the signal received by the second terminal UE_0, H₀₀ expresses a space channel between the second base station and the second terminal, and N₀ expresses a noise signal received by the second terminal UE_0.

The first terminal UE_1 performs same processing as that in embodiment 1 on Y1 to obtain shared information and sends the shared information to the second terminal UE_0, and the second terminal UE_0 performs same processing as that in embodiment 1 on Y₁ and Y₀ to obtain information that the network side needs to send to the second terminal.

For example, the second terminal UE_0 obtains the following receiving signal according to obtained channel information:

$$Y = [ \begin{matrix}{Y}_{0} \\ {Y}_{1}\end{matrix} ] = [ \begin{matrix}{H}_{00} \\ {H}_{01}\end{matrix} ] \cdot {S}_{0} + [ \begin{matrix}{N}_{0} \\ {N}_{1}\end{matrix} ] .$$

According to a receiver W₀ adopted by the second terminal UE_0, an estimated value of S0 sent by the second base station BS_0 may be obtained:

Ŝ₀=W₀·Y.

The second terminal UE_0 demodulates Ŝ₀ via [H₀₀ H₀₁]^{T} to achieve sharing of the first terminal UE_{—} 1, thereby improving a quality of the received signal of the second terminal UE_0.

According to the method for inter-terminal coordinated communication provided by the embodiment of the present patent application, the second terminal receives the shared information sent by the first terminal and obtains the information that the network side needs to send to the second terminal according to the shared information and the signal received by the second terminal from the network side. Problems in the prior art that the network side needs to jointly process a signal sent by the network side which increases a complexity of information processing of the network side, and that a terminal needs to completely demodulate information of other terminals which increases a processing load of the terminal are overcome.

### Embodiment 3

The above-mentioned first application scenario is selected for illustration in the embodiment. A principle of the embodiment is same as that of the embodiment 1. A difference is that a manner in which the first terminal UE_1 obtains a shared signal is different, and only the difference is illustrated herein.

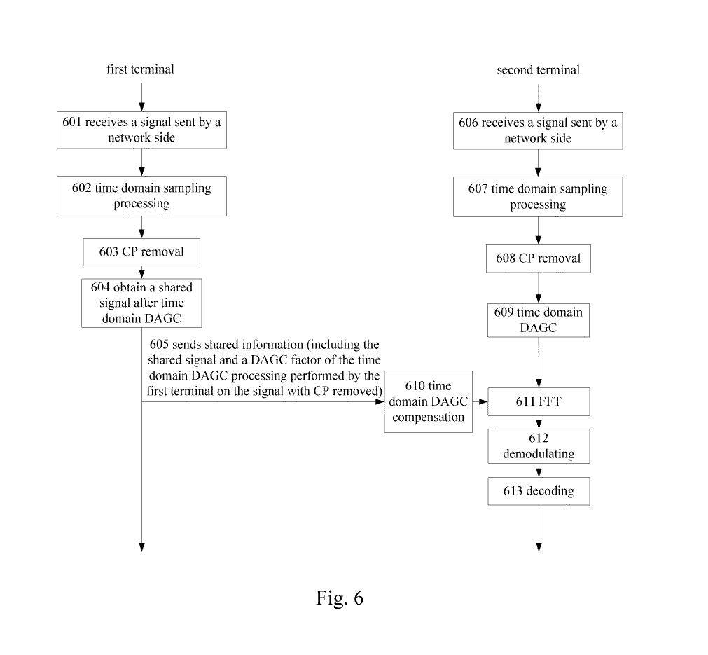

Referring to FIG. 6, the following is included.

S601: a first terminal receives a signal sent by a network side.

S602: the first terminal performs time domain sampling processing on the signal received by the first terminal from the network side.

S603: the first terminal performs CP removal processing on the signal after the time domain sampling processing.

S604: the first terminal performs time domain DAGC processing on the signal with CP removed to obtain a shared signal.

Exemplarily, by means of the time domain DAGC processing, information amount of the shared signal may be reduced, thus a data size of inter-terminal transmission may be reduced.

S605: the first terminal sends shared information to a second terminal.

Exemplarily, the shared information includes the shared signal and a DAGC factor of the time domain DAGC processing performed by the first terminal on the signal with CP removed.

S606: the second terminal receives a signal sent by the network side.

S607: the second terminal performs time domain sampling processing on the signal received by the second terminal from the network side.

S608: the second terminal performs CP removal processing on the shared signal and the signal received by the second terminal from the network side.

S609: the second terminal performs time domain DAGC processing on the signal, with CP removed, received by the second terminal from the network side.

S610: the second terminal performs DAGC compensation processing on the shared signal.

S611: the second terminal performs FFT processing on the shared signal after the DAGC compensation processing and the signal received by the second terminal from the network side after the DAGC processing.

S612: the second terminal demodulates the shared signal after the FFT processing and the signal received by the second terminal from the network side after the FFT processing.

Exemplarily, the second terminal may obtain information of H₀₁ by channel estimation in demodulating process of itself, such that the second terminal obtains information that the network side needs to send to the second terminal according to H₀₁.

S613: the second terminal decodes the demodulated shared signal and the demodulated signal received by the second terminal from the network side.

For example, the second terminal UE_0 obtains the following receiving signal according to obtained channel information:

$$Y = [ \begin{matrix}{Y}_{0} \\ {Y}_{1}\end{matrix} ] = [ \begin{matrix}{H}_{00} \\ {H}_{01}\end{matrix} ] \cdot {S}_{0} + [ \begin{matrix}{H}_{10} \\ {H}_{11}\end{matrix} ] \cdot {S}_{1} + [ \begin{matrix}{N}_{0} \\ {N}_{1}\end{matrix} ] .$$

According to a receiver W₀ adopted by the second terminal UE_0, an estimated value of S0 sent by the second base station BS_0 may be obtained:

Ŝ₀=W₀˜Y.

The second terminal UE_0 demodulates Ŝ₀ via [H₀₀ H₀₁]^{T} to achieve sharing of the first terminal UE_1, thereby improving a quality of the received signal of the second terminal UE_0.

According to the method for inter-terminal coordinated communication provided by the embodiment of the present patent application, the second terminal receives the shared information sent by the first terminal and obtains the information that the network side needs to send to the second terminal according to the shared information and the signal received by the second terminal from the network side. The shared information is obtained by the first terminal after performing the time domain DAGC processing on the information received by the first terminal from the network side. So the information amount of the shared signal is reduced, thus the data size of the inter-terminal transmission may be reduced. Problems in the prior art that the network side needs to jointly process a signal sent by the network side which increases a complexity of information processing of the network side, and that a terminal needs to completely demodulate information of other terminals which increases a processing load of the terminal are overcome.

### Embodiment 4

The above-mentioned first application scenario is selected for illustration in the embodiment. A principle of the embodiment is same as that of the embodiment 1. A difference is that a manner in which the first terminal UE_1 obtains a shared signal is different, and only the difference is illustrated herein.

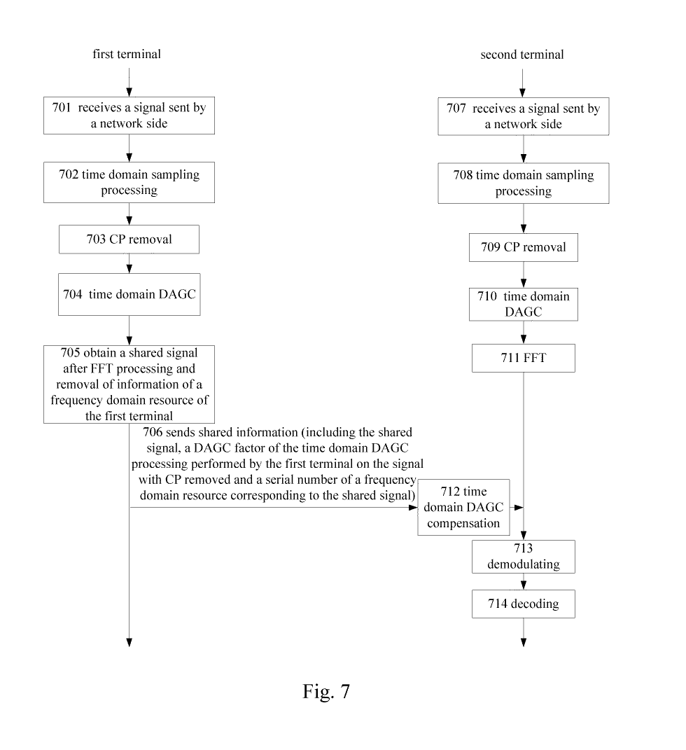

Referring to FIG. 7, the following is included.

S701: a first terminal receives a signal sent by a network side.

S702: the first terminal performs time domain sampling processing on the signal received from the network side.

S703: the first terminal performs CP removal processing on the signal after the time domain sampling processing.

S704: the first terminal performs time domain DAGC processing on the signal with CP removed.

Exemplarily, by means of the time domain DAGC processing, information amount of the shared signal may be reduced, thus a data size of inter-terminal transmission may be reduced.

S705: the first terminal performs FFT processing and removal of information carried on a frequency domain resource of the first terminal on the signal after the time domain DAGC processing to obtain a shared signal.

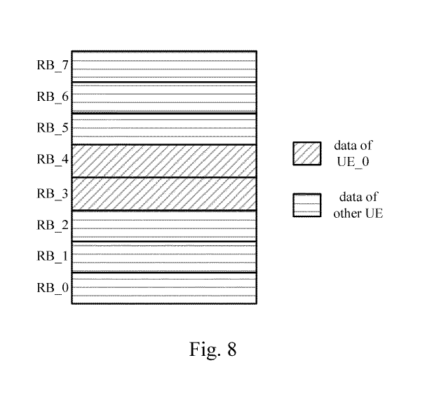

Exemplarily, after performing the FFT processing on the signal after the time domain DAGC processing, the first terminal UE_1 may obtain information carried on a frequency domain resource as shown in FIG. 8. The information carried on the frequency domain resource is identified by a resource block (RB), namely a serial number of a frequency domain resource in the embodiment. For example, serial numbers of frequency domain resources allocated to the first terminal UE_1 by a system are RB_3 and RB_4, and information carried on other frequency domain resources is allocated to other terminals, in which information carried on a frequency domain resource allocated to the second terminal UE_0 may be included. After extracting information carried on frequency domain resources of RB_3 and RB_4, the first terminal UE_1 obtains the shared signal, namely, information carried on frequency domain resources respectively corresponding to RB_0, RB_1, RB_2, RB_5, RB_6 and RB_7.

S706: the first terminal sends shared information to a second terminal

Exemplarily, the shared information includes the shared signal, a DAGC factor of the time domain DAGC processing performed by the first terminal on the signal with CP removed and a serial number of a frequency domain resource corresponding to the shared signal.

S707: the second terminal receives a signal sent by the network side.

S708: the second terminal performs time domain sampling processing on the signal received by the second terminal from the network side.

S709: the second terminal performs CP removal processing on the signal received by the second terminal from the network side after the time domain sampling processing.

S710: the second terminal performs time domain DAGC processing on the signal, with CP removed, received by the second terminal from the network side.

S711: the second terminal performs FFT processing on the signal received by the second terminal from the network side after the DAGC processing.

S712: the second terminal performs DAGC compensation processing on the shared signal according to the DAGC factor of the DAGC processing performed on the signal received by the first terminal from the network side.

S713: the second terminal demodulates the shared signal after the DAGC compensation processing and the signal received by the second terminal from the network side after the FFT processing according to a resource identity allocated by the system to the second terminal.

S714: the second terminal decodes the demodulated shared signal and the demodulated signal received by the second terminal from the network side.

Exemplarily, the second terminal UE_0 obtains the following receiving signal according to obtained channel information:

$$Y = [ \begin{matrix}{Y}_{0} \\ {Y}_{1}\end{matrix} ] = [ \begin{matrix}{H}_{00} \\ {H}_{01}\end{matrix} ] \cdot {S}_{0} + [ \begin{matrix}{H}_{10} \\ {H}_{11}\end{matrix} ] \cdot {S}_{1} + [ \begin{matrix}{N}_{0} \\ {N}_{1}\end{matrix} ] .$$

According to a receiver W₀ adopted by the second terminal UE_0, an estimated value of S0 sent by the second base station BS_0 may be obtained:

Ŝ₀=W₀·Y.

The second terminal UE_0 demodulates Ŝ₀ via [H₀₀ H₀₁]^{T} to achieve sharing of the first terminal UE_{—} 1, thereby improving a quality of the received signal of the second terminal UE_0.

According to the method for inter-terminal coordinated communication provided by the embodiment of the present patent application, the second terminal receives the shared information sent by the first terminal and obtains the information that the network side needs to send to the second terminal according to the shared information and the signal received by the second terminal from the network side. The shared information is obtained by the first terminal after performing the FFT processing on the information received by the first terminal from the network side and removing the information carried on the frequency domain resource of the first terminal. This not only reduces the information amount of the shared signal and reduces the data size of the inter-terminal transmission, but also enables the second terminal to find data needed by itself via an RB serial number according to the resource identity allocated by the system to the second terminal Problems in the prior art that the network side needs to jointly process a signal sent by the network side which increases a complexity of information processing of the network side, and that a terminal needs to completely demodulate information of other terminals which increases a processing load of the terminal are overcome.

### Embodiment 5

The above-mentioned second application scenario is selected for illustration in the embodiment. A principle of the embodiment is same as that of the embodiment 2. A difference is that a manner in which the first terminal UE_1 obtains a shared signal is different, and only the difference is illustrated herein.

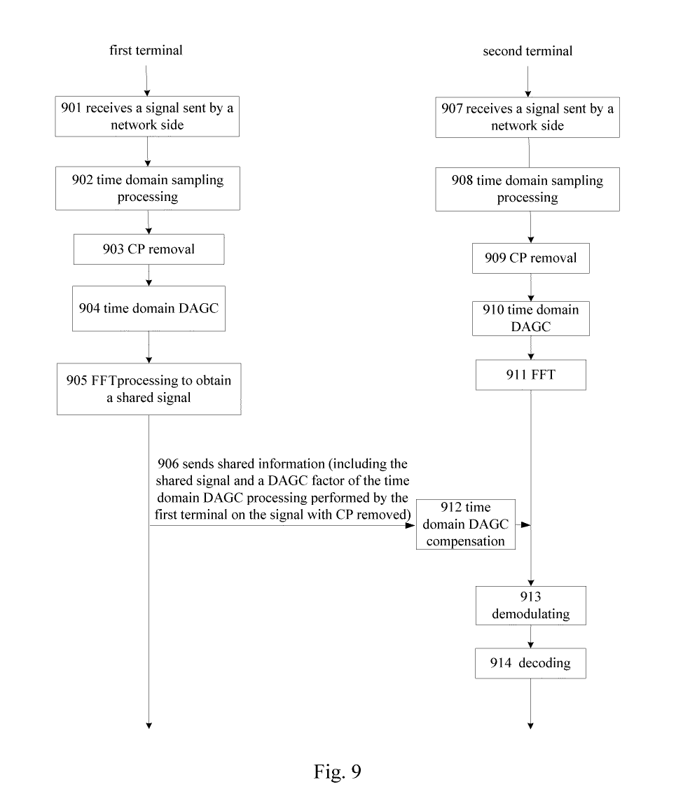

Referring to FIG. 9, the following is included.

S901: the first terminal receives a signal sent by a network side.

S902: the first terminal performs time domain sampling processing on the signal received from the network side.

S903: the first terminal removes CP from the signal after the time domain sampling processing.

S904: the first terminal performs time domain DAGC processing on the signal with CP removed.

Exemplarily, by means of the time domain DAGC processing, information amount of the shared signal may be reduced, thus a data size of inter-terminal transmission may be reduced.

S905: the first terminal performs FFT processing on the signal after the time domain DAGC processing to obtain a shared signal.

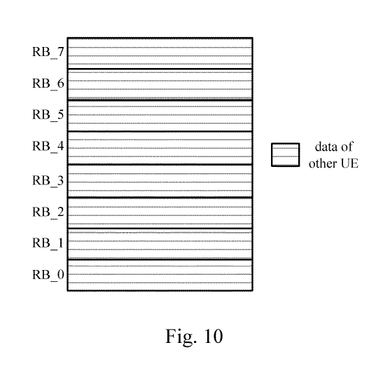

Exemplarily, after performing the FFT processing on the signal after the time domain DAGC processing, the first terminal UE_1 may obtain information carried on a frequency domain resource corresponding to the shared signal, as shown in FIG. 10, namely a serial number of a frequency domain resource in the embodiment. The information carried on the frequency domain resource is identified by RB. All information carried on the frequency domain resource corresponding to the shared signal is information of other terminals, in which information carried on a frequency domain resource allocated to the second terminal UE_0 are included. The shared signal is information carried on all frequency domain resources after the FFT processing, namely, information carried on frequency domain resources respectively corresponding to RB_0, RB_1, RB_2, RB_3, RB_4, RB_5, RB_6, RB_7.

S906: the first terminal sends shared information to the second terminal.

Exemplarily, the shared information includes the shared signal and a DAGC factor of the time domain DAGC processing performed by the first terminal on the signal with CP removed.

S907: the second terminal receives a signal sent by the network side.

S908: the second terminal performs time domain sampling processing on the signal received by the second terminal from the network side.

S909: the second terminal removes CP from the signal after the time domain sampling processing and received by the second terminal from the network side.

S910: the second terminal performs time domain DAGC processing on the signal with CP removed and received by the second terminal from the network side.

S911: the second terminal performs FFT processing on the signal after the DAGC processing and received by the second terminal from the network side.

S912: the second terminal performs DAGC compensation processing on the shared signal according to a DAGC factor of the time domain DAGC processing performed on the signal received by the first terminal from the network side.

S913: the second terminal demodulates the shared signal after the DAGC compensation processing and the signal after the FFT processing and received by the second terminal from the network side according to a resource identity allocated by a system to the second terminal.

S914: the second terminal decodes the demodulated shared signal and the demodulated signal received by the second terminal from the network side.

For example, the second terminal obtains the following receiving signal according to obtained channel information:

$$Y = [ \begin{matrix}{Y}_{0} \\ {Y}_{1}\end{matrix} ] = [ \begin{matrix}{H}_{00} \\ {H}_{01}\end{matrix} ] \cdot {S}_{0} + [ \begin{matrix}{N}_{0} \\ {N}_{1}\end{matrix} ] .$$

According to a receiver W₀ adopted by the second terminal UE_0, an estimated value of S0 sent by the second base station BS_0 may be obtained:

Ŝ₀=W₀·Y.

The second terminal UE_0 demodulates Ŝ₀ via [H₀₀ H₀₁]^{T} to achieve sharing of the first terminal UE_{—} 1, thereby improving a quality of the received signal of the second terminal UE_0.

According to the method for inter-terminal coordinated communication provided by the embodiment of the present patent application, the second terminal receives the shared information sent by the first terminal and obtains the information that the network side needs to send to the second terminal according to the shared information and the signal received by the second terminal from the network side. The shared information is obtained by the first terminal after performing the FFT processing on the information received by the first terminal from the network side. This not only reduces the information amount of the shared signal and reduces the data size of the inter-terminal transmission, but also enables the second terminal to find data needed by itself via an RB serial number according to the resource identity allocated by the system to the second terminal. Problems in the prior art that the network side needs to jointly process a signal sent by the network side which increases a complexity of information processing of the network side, and that a terminal needs to completely demodulate information of other terminals which increases a processing load of the terminal are overcome.

### Embodiment 6

The above-mentioned first application scenario is selected for illustration in the embodiment. A principle of the embodiment is same as that of the embodiment 1. A difference is that a manner in which the first terminal UE_1 obtains a shared signal is different, and only the difference is illustrated herein.

Referring to FIG. 11, the following is included.

S1101: the first terminal receives a signal sent by a network side.

S1102: the first terminal performs time domain sampling processing on the signal received from the network side.

S1103: the first terminal removes CP from the signal after the time domain sampling processing.

S1104: the first terminal performs time domain DAGC processing on the signal with CP removed.

Exemplarily, by means of the time domain DAGC processing, information amount of the shared signal may be reduced, thus a data size of inter-terminal transmission may be reduced.

S1105: the first terminal performs FFT processing on the signal after the time domain DAGC processing and removes information carried on a frequency domain resource of the first terminal.

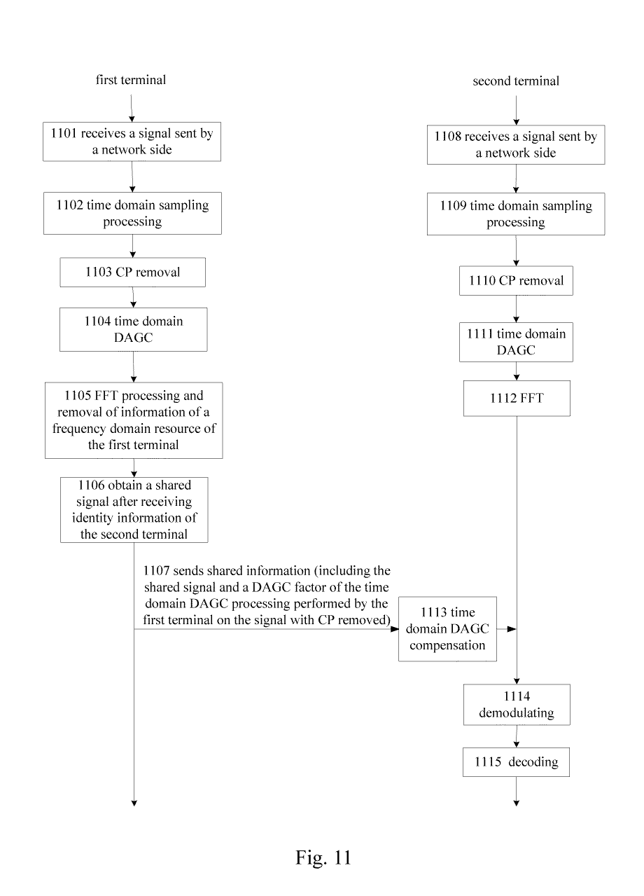

Exemplarily, after performing the FFT processing on the signal after the time domain DAGC processing, the first terminal UE_1 obtains information carried on a frequency domain resource, as shown in FIG. 12. The information carried on the frequency domain resource is identified by RB, namely a serial number of a frequency domain resource in the embodiment. For example, serial numbers of frequency domain resources allocated by a system to the first terminal UE_1 are RB_3 and RB_4, serial numbers of frequency domain resources allocated by the system to the second terminal UE_0 are RB_1 and RB_2, and information carried on other frequency domain resources is allocated to other terminals. The first terminal UE_1 extracts information carried on frequency domain resources of RB_3 and RB_4.

S1106: the first terminal obtains a shared signal after receiving identity information of the second terminal.

Exemplarily, the first terminal obtains a serial number of a frequency domain resource of the second terminal according to the identity information of the second terminal to obtain a signal belonging to the second terminal in the signal after the FFT processing, so as to obtain the shared signal, and the shared signal is information carried on the frequency domain resource corresponding to the second terminal.

Exemplarily, for information carried on other frequency domain resources, according to the identity information of the second terminal UE_0, the first terminal UE_1 may find a position of a time frequency resource where the information carried on the frequency domain resource of the second terminal UE_0 is located. The first terminal UE_1 estimates a quality of the information carried on the frequency domain resources of the second terminal UE_0, namely, the first terminal UE_1 estimates the quality of information carried on frequency domain resources corresponding to RB_1 and RB_2 of the second terminal UE_0. If the quality of the information carried on the frequency domain resources corresponding to RB_1 and RB_2 is less than a preset threshold, there is no shared signal, because the UE_1 obtains information carried on a frequency domain resource with a low quality, and a quality of the received signal cannot be improved.

Exemplarily, if the quality of the information carried on the frequency domain resources corresponding to RB_1 and RB_2 is greater than or equal to the preset threshold, the information carried on the frequency domain resources corresponding to RB_1 and RB_2 of the second terminal UE_0 is the shared signal.

Exemplarily, the preset threshold is determined according to a signal-noise ratio threshold corresponding to a modulating and coding solution adopted by the second terminal UE_0. The second terminal UE_0 may look up a signal-noise ratio threshold table corresponding to a channel quality indicator (CQI) feedback to obtain the signal-noise ratio threshold. The signal-noise ratio threshold table is determined by specific implementation of a terminal manufacturer.

S1107: the first terminal sends shared information to the second terminal.

Exemplarily, when the signal quality of the shared signal is less than the preset threshold, the first terminal does not send the shared information to the second terminal.

Or,

when the signal quality of the shared signal is greater than or equal to the preset threshold, the first terminal sends the shared information to the second terminal.

Exemplarily, the shared information includes the shared signal and a DAGC factor of the time domain DAGC processing performed by the first terminal on the signal with CP removed.

Exemplarily, the shared information includes the shared signal and a DAGC factor of the time domain DAGC processing performed by the first terminal on the signal with CP removed.

S1108: the second terminal receives a signal sent by the network side.

S1109: the second terminal performs time domain sampling processing on the signal received by the second terminal from the network side.

S1110: the second terminal removes CP from the signal after the time domain sampling processing and received by the second terminal from the network side.

S1111: the second terminal performs time domain DAGC processing on the signal with CP removed and received by the second terminal from the network side.

S1112: the second terminal performs FFT processing on the signal after the DAGC processing and received by the second terminal from the network side.

S1113: the second terminal performs DAGC compensation processing on the shared signal according to the DAGC factor of the time domain DAGC processing performed on the signal received by the first terminal from the network side.

S1114: the second terminal demodulates the shared signal after the DAGC compensation processing and the signal after the FFT processing and received by the second terminal from the network side according to a resource identity allocated by the system to the second terminal.

S1115: the second terminal decodes the demodulated shared signal and the demodulated signal received by the second terminal from the network side.

Exemplarily, the second terminal UE_0 obtains the following receiving signal according to obtained channel information:

$$Y = [ \begin{matrix}{Y}_{0} \\ {Y}_{1}\end{matrix} ] = [ \begin{matrix}{H}_{00} \\ {H}_{01}\end{matrix} ] \cdot {S}_{0} + [ \begin{matrix}{H}_{10} \\ {H}_{11}\end{matrix} ] \cdot {S}_{1} + [ \begin{matrix}{N}_{0} \\ {N}_{1}\end{matrix} ] .$$

According to a receiver W₀ adopted by the second terminal UE_0, an estimated value of S0 sent by the second base station BS_0 may be obtained:

Ŝ₀=W₀·Y.

The second terminal UE_0 demodulates Ŝ₀ via [H₀₀ H₀₁]^{T} to achieve sharing of the first terminal UE_{—} 1, thereby improving a quality of the received signal of the second terminal UE_0.

According to the method for inter-terminal coordinated communication provided by the embodiment of the present patent application, the second terminal receives the shared information sent by the first terminal and obtains the information that the network side needs to send to the second terminal according to the shared information and the signal received by the second terminal from the network side. The shared information is obtained by the first terminal after performing the FFT processing on the information received by the first terminal from the network side. This reduces the information amount of the shared signal, thus reduces the data size of the inter-terminal transmission. Problems in the prior art that the network side needs to jointly process a signal sent by the network side which increases a complexity of information processing of the network side, and that a terminal needs to completely demodulate information of other terminals which increases a processing load of the terminal are overcome.

### Embodiment 7

The above-mentioned second application scenario is selected for illustration in the embodiment. A principle of the embodiment is same as that of the embodiment 2. A difference is that a manner in which the first terminal UE_1 obtains a shared signal is different, and only the difference is illustrated herein.

Referring to FIG. 11, the following is included.

S1101: the first terminal receives a signal sent by a network side.

S1102: the first terminal performs time domain sampling processing on the signal received from the network side.

S1103: the first terminal removes CP from the signal after the time domain sampling processing.

S1104: the first terminal performs time domain DAGC processing on the signal with CP removed.

Exemplarily, by means of the time domain DAGC processing, information amount of the shared signal may be reduced, thus a data size of inter-terminal transmission may be reduced.

S1105: the first terminal performs FFT processing on the signal after the time domain DAGC processing.

Exemplarily, after performing the FFT processing on the signal after the time domain DAGC processing, the first terminal UE_1 obtains information carried on a frequency domain resource, as shown in FIG. 13. The information carried on the frequency domain resource is identified by RB, namely a serial number of a frequency domain resource in the embodiment. For example, serial numbers of frequency domain resources allocated by a system to the second terminal UE_0 are RB_1 and RB_2, and information carried on other frequency domain resources is allocated to other terminals.

S1106: the first terminal obtains a shared signal after receiving identity information of the second terminal.

Exemplarily, the first terminal UE_1 obtains a serial number of a frequency domain resource of the second terminal UE_0 according to the identity information of the second terminal UE_0 to obtain a signal belonging to the second terminal UE_0 in the signal after the FFT processing, so as to obtain the shared signal, and the shared signal is information carried on the frequency domain resource corresponding to the second terminal UE_0.

Exemplarily, for information carried on other frequency domain resources, according to the identity information of the second terminal UE_0, the first terminal UE_1 may find a position of a frequency domain resource where the information carried on the frequency domain resource of the second terminal UE_0 is located. The first terminal UE_1 estimates a quality of the information carried on the frequency domain resources of the second terminal UE_0, namely, the first terminal UE_1 estimates the quality of information carried on frequency domain resources corresponding to RB_1 and RB_2 of the second terminal UE_0. If the quality of the information carried on the frequency domain resources corresponding to RB_1 and RB_2 is less than a preset threshold, there is no shared signal, because the UE_1 obtains information carried on a frequency domain resource with a low quality, and a quality of the received signal cannot be improved.

Exemplarily, if the quality of the information carried on the frequency domain resources corresponding to RB_1 and RB_2 is greater than or equal to the preset threshold, the information carried on the frequency domain resources corresponding to RB_1 and RB_2 of the second terminal UE_0 is the shared signal.

Exemplarily, the preset threshold is determined according to a signal-noise ratio threshold corresponding to a modulating and coding solution adopted by the second terminal UE_0. The second terminal UE_0 may look up a signal-noise ratio threshold table corresponding to a channel quality indicator (CQI) feedback to obtain the signal-noise ratio threshold. The signal-noise ratio threshold table is determined by specific implementation of a terminal manufacturer.

S1107: the first terminal sends the shared information to the second terminal.

Exemplarily, when the signal quality of the shared signal is less than the preset threshold, the first terminal does not send the shared information to the second terminal.

Or,

when the signal quality of the shared signal is greater than or equal to the preset threshold, the first terminal sends the shared information to the second terminal.

Exemplarily, the shared information includes the shared signal and a DAGC factor of the time domain DAGC processing performed by the first terminal on the signal with CP removed.

S1108: the second terminal receives a signal sent by the network side.

S1109: the second terminal performs time domain sampling processing on the signal received by the second terminal from the network side.

S1110: the second terminal removes CP from the signal after the time domain sampling processing and received by the second terminal from the network side.

S1111: the second terminal performs time domain DAGC processing on the signal with CP removed and received by the second terminal from the network side.

S1112: the second terminal performs FFT processing on the signal after the DAGC processing and received by the second terminal from the network side.

S1113: the second terminal performs DAGC compensation processing on the shared signal according to the DAGC factor of the time domain DAGC processing performed on the signal received by the first terminal from the network side.

S1114: the second terminal demodulates the shared signal after the DAGC compensation processing and the signal after the FFT processing and received by the second terminal from the network side according to a resource identity allocated by the system to the second terminal.

S1115: the second terminal decodes the demodulated shared signal and the demodulated signal received by the second terminal from the network side.

For example, the second terminal obtains the following receiving signal according to obtained channel information:

$$Y = [ \begin{matrix}{Y}_{0} \\ {Y}_{1}\end{matrix} ] = [ \begin{matrix}{H}_{00} \\ {H}_{01}\end{matrix} ] \cdot {S}_{0} + [ \begin{matrix}{N}_{0} \\ {N}_{1}\end{matrix} ] .$$

According to a receiver W₀ adopted by the second terminal UE_0, an estimated value of S0 sent by the second base station BS_0 may be obtained:

Ŝ₀=W₀·Y.

The second terminal UE_0 demodulates Ŝ₀ via [H₀₀ H₀₁]^{T} to achieve sharing of the first terminal UE_{—} 1, thereby improving a quality of the received signal of the second terminal UE_0.

According to the method for inter-terminal coordinated communication provided by the embodiment of the present patent application, the second terminal receives the shared information sent by the first terminal and obtains the information that the network side needs to send to the second terminal according to the shared information and the signal received by the second terminal from the network side. The shared information is obtained by the first terminal after performing the FFT processing on the information received by the first terminal from the network side. This reduces the information amount of the shared signal, thus reduces the data size of the inter-terminal transmission. Problems in the prior art that the network side needs to jointly process a signal sent by the network side which increases a complexity of information processing of the network side, and that a terminal needs to completely demodulate information of other terminals which increases a processing load of the terminal are overcome.

### Embodiment 8

The above-mentioned first application scenario is selected for illustration in the embodiment. A principle of the embodiment is same as that of the embodiment 1. A difference is that a manner in which the first terminal UE_1 obtains a shared signal is different, and only the difference is illustrated herein.

Referring to FIG. 9, the following is included.

S901: the first terminal receives a signal sent by a network side.

S902: the first terminal performs time domain sampling processing on the signal received from the network side.

S903: the first terminal removes CP from the signal after the time domain sampling processing.

S904: the first terminal performs time domain DAGC processing on the signal with CP removed.

Exemplarily, by means of the time domain DAGC processing, information amount of the shared signal may be reduced, thus a data size of inter-terminal transmission may be reduced.

S905: the first terminal performs FFT processing on the signal after the time domain DAGC processing to obtain a shared signal.

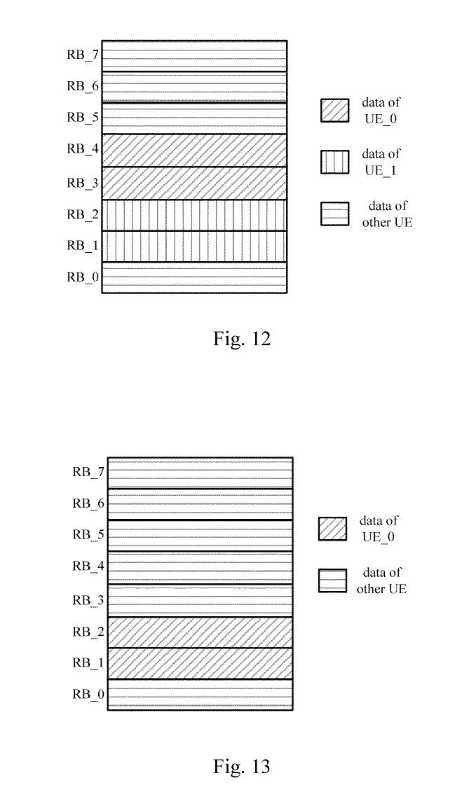

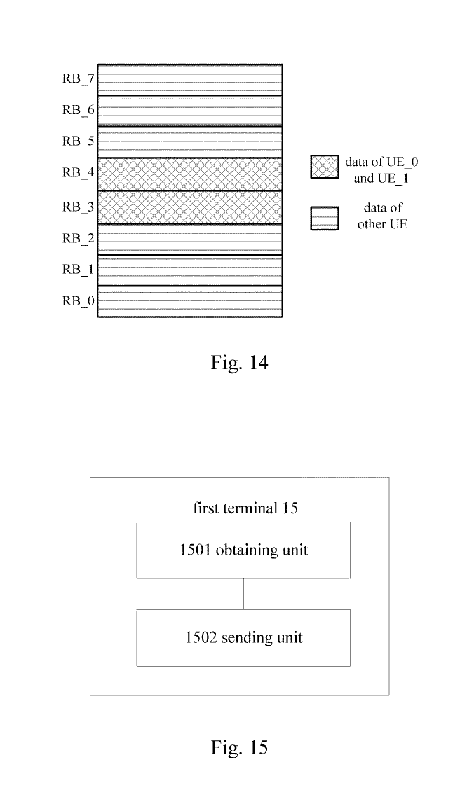

Exemplarily, after performing the FFT processing on the signal after the time domain DAGC processing, the first terminal UE_1 may obtain information carried on a frequency domain resource, as shown in FIG. 14, namely a serial number of a frequency domain resource in the embodiment. The information carried on the frequency domain resource is identified by RB. For example, information carried on frequency domain resources allocated by a system to the first terminal UE_1 is RB_3 and RB_4, meanwhile, by means of a spatial multiplexing technology, the information RB_3 and RB_4 carried on the frequency domain resources is allocated to the second terminal UE_0, namely information carried on frequency domain resources of the second terminal UE_0 and the first terminal UE_1 is carried on a same frequency domain resource block, and information carried on other frequency domain resources is information of other terminals. The shared signal is information carried on all frequency domain resources after the FFT processing, namely, information carried on frequency domain resources respectively corresponding to RB_0, RB_1, RB_2, RB_3, RB_4, RB_5, RB_6, RB_7.

S906: the first terminal sends shared information to the second terminal.

Exemplarily, the shared information includes the shared signal and a DAGC factor of the time domain DAGC processing performed by the first terminal on the signal with CP removed.

S907: the second terminal receives a signal sent by the network side.

S908: the second terminal performs time domain sampling processing on the signal received by the second terminal from the network side.

S909: the second terminal removes CP from the signal after the time domain sampling processing and received by the second terminal from the network side.

S910: the second terminal performs time domain DAGC processing on the signal with CP removed and received by the second terminal from the network side.

S911: the second terminal performs FFT processing on the signal after the DAGC processing and received by the second terminal from the network side.

S912: the second terminal performs DAGC compensation processing on the shared signal according to a DAGC factor of the time domain DAGC processing performed on the signal received by the first terminal from the network side.

S913: the second terminal demodulates the shared signal after the DAGC compensation processing and the signal after the FFT processing and received by the second terminal from the network side according to a resource identity allocated by the system to the second terminal.

S914: the second terminal decodes the demodulated shared signal and the demodulated signal received by the second terminal from the network side.

For example, the second terminal obtains the following receiving signal according to obtained channel information:

$$Y = [ \begin{matrix}{Y}_{0} \\ {Y}_{1}\end{matrix} ] = [ \begin{matrix}{H}_{00} \\ {H}_{01}\end{matrix} ] \cdot {S}_{0} + [ \begin{matrix}{H}_{10} \\ {H}_{11}\end{matrix} ] \cdot {S}_{1} + [ \begin{matrix}{N}_{0} \\ {N}_{1}\end{matrix} ] .$$

According to a receiver W₀ adopted by the second terminal UE_0, an estimated value of S0 sent by the second base station BS_0 may be obtained:

Ŝ₀=W₀·Y.

The second terminal UE_0 demodulates Ŝ₀ via [H₀₀ H₀₁]^{T} to achieve sharing of the first terminal UE_1, thereby improving a quality of the received signal of the second terminal UE_0.

According to the method for inter-terminal coordinated communication provided by the embodiment of the present patent application, the second terminal receives the shared information sent by the first terminal and obtains the information that the network side needs to send to the second terminal according to the shared information and the signal received by the second terminal from the network side. The shared information is obtained by the first terminal after performing the FFT processing on the information received by the first terminal from the network side, This not only reduces the information amount of the shared signal and reduces the data size of the inter-terminal transmission, but also enables the second terminal to find data needed by itself via an RB serial number according to the resource identity allocated by the system to the second terminal. Problems in the prior art that the network side needs to jointly process a signal sent by the network side which increases a complexity of information processing of the network side, and that a terminal needs to completely demodulate information of other terminals which increases a processing load of the terminal are overcome.

FIG. 15 is an apparatus schematic diagram of a first terminal 15 provided by an embodiment of the present patent application. Referring to the figure, the first terminal 15 includes:

an obtaining unit 1501, configured to obtain a shared signal according to a signal received by the first terminal 15 from a network side, and transmit the shared signal to a sending unit 1502; and

the sending unit 1502, configured to send shared information to a second terminal, for enabling the second terminal to obtain information that the network side needs to send to the second terminal according to the shared information and a signal received by the second terminal from the network side, where the shared information includes the shared signal.

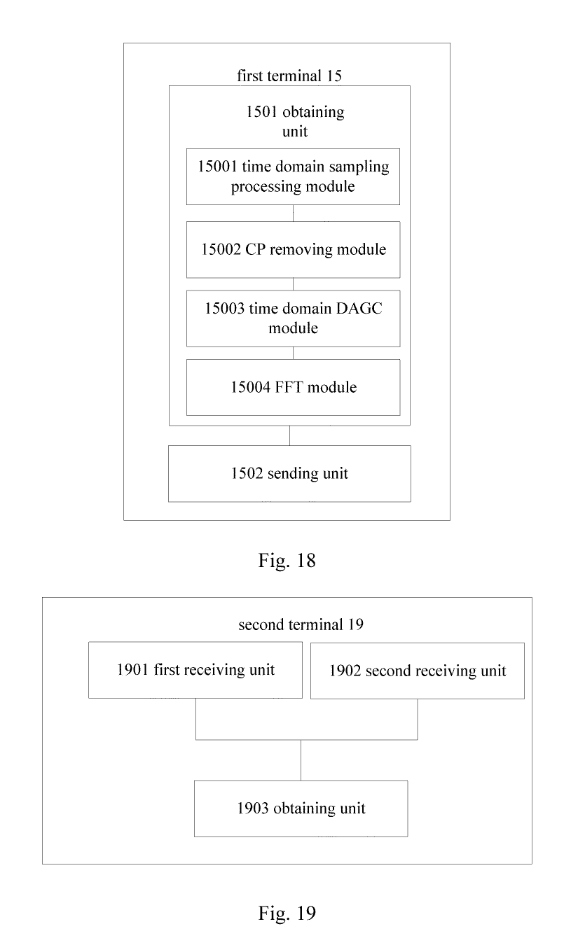

Further, referring to FIG. 18, the obtaining unit 1501 may include:

a time domain sampling processing module 15001, configured to perform time domain sampling processing on the signal received by the first terminal from the network side to obtain the shared signal;

a CP removing module 15002, configured to remove a cyclic prefix (CP) from a signal processed by the time domain sampling processing module; and

a time domain DAGC module 15003, configured to perform time domain digital automatic gain control (DAGC) processing on a signal processed by the CP removing module to obtain the shared signal; and

the shared information further includes a DAGC factor of the time domain DAGC processing performed by the first terminal on the signal received by the first terminal from the network side.

An FFT module 15004 is configured to perform fast Fourier transform (FFT) and removal of information carried on a frequency domain resource of the first terminal on the signal processed by the time domain DAGC module to obtain the shared signal; and

the shared information further includes a DAGC factor of the time domain DAGC processing performed by the first terminal on the signal received by the first terminal from the network side and a serial number of a frequency domain resource corresponding to the shared signal.

The FFT module 15004 is further configured to perform FFT on a signal processed by the time domain DAGC module to obtain the shared signal; and

the shared information further includes a DAGC factor of the time domain DAGC processing performed by the first terminal on the signal received by the first terminal from the network side.

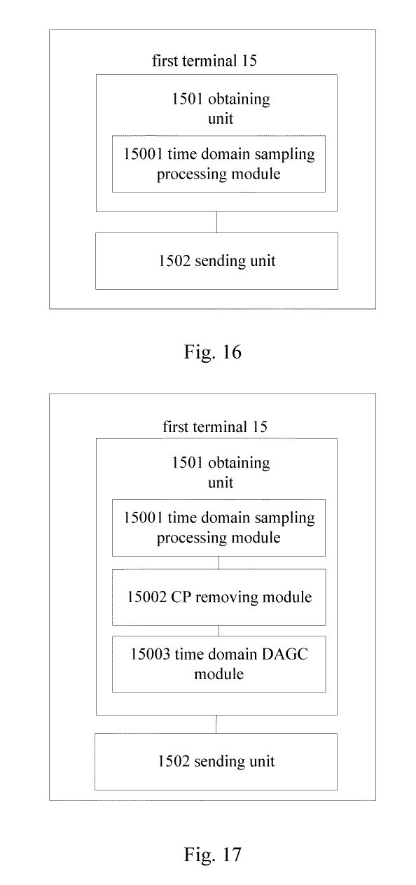

Exemplarily, referring to FIG. 16 to FIG. 18, the obtaining unit 1501 in the embodiment of the present patent application may only include the time domain sampling processing module 15001; or the obtaining unit 1501 may include the time domain sampling processing module 15001, the CP removing module 15002 and the time domain DAGC module 15003; or the obtaining unit 1501 includes the time domain sampling processing module 15001, the CP removing module 15002, the time domain DAGC module 15003 and the FFT module 15004.

According to an inter-terminal coordinated communication device provided by the embodiment of the present patent application, the first terminal 15 obtains the shared signal according to the signal received by the first terminal 15 from the network side. The first terminal 15 sends the shared information to the second terminal, for enabling the second terminal to obtain the information that the network side needs to send to the second terminal according to the shared information and the signal received by the second terminal from the network side. The shared information includes the shared signal. Problems in the prior art that the network side needs to jointly process a signal sent by the network side which increases a complexity of information processing of the network side, and that a terminal needs to completely demodulate information of other terminals which increases a processing load of the terminal are overcome.

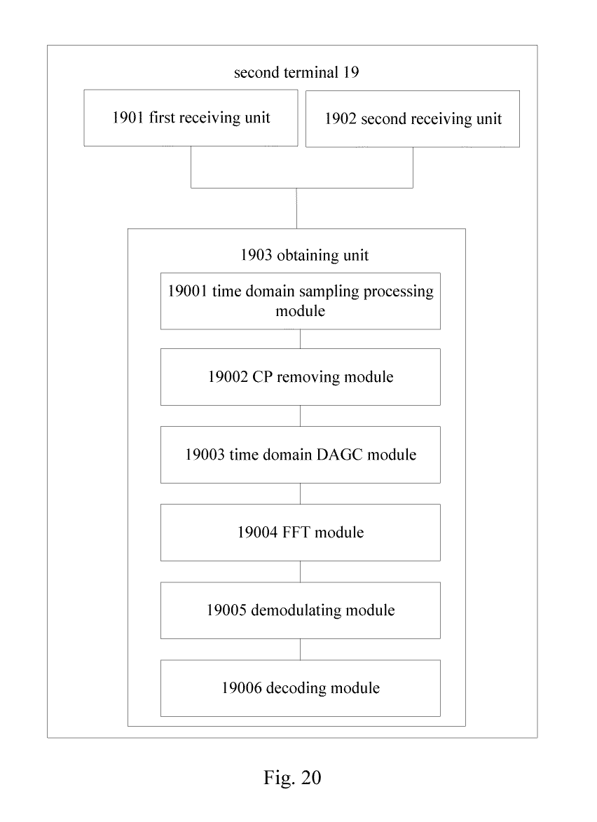

FIG. 19 or FIG. 20 is a schematic diagram of a coordinated communication device of a second terminal side. Referring to FIG. 19 or FIG. 20, a second terminal 19 includes:

a first receiving unit 1901, configured to receive shared information sent by a first terminal and transmit the shared information to an obtaining unit 1903, where the shared information includes a shared signal obtained by the first terminal according to a signal received by the first terminal from a network side;

a second receiving unit 1902, configured to receive a signal from the network side and transmit the signal to the obtaining unit 1903; and

the obtaining unit 1903, configured to obtain information that the network side needs to send to the second terminal 19 according to the shared information and the signal received by the second receiving unit 1902 from the network side.

Exemplarily, the information that the network side needs to send to the second terminal 19 includes information of the second terminal 19 in the shared signal and information of the second terminal 19 received by the second terminal 1902.

Exemplarily, the obtaining unit 1903 may include:

a time domain sampling processing module 19001, configured to perform time domain sampling processing on the signal received by the second receiving unit 1902 from the network side;

a CP removing module 19002, configured to perform cyclic prefix (CP) removal processing on the shared signal and a signal processed by the time domain sampling processing module 18001 and received by the second receiving unit 1902 from the network side;

the CP removing module 19002 is further configured to perform cyclic prefix (CP) removal processing on a signal processed by the time domain sampling processing module 19002;

a time domain DAGC module 19003, configured to perform time domain DAGC processing on a signal processed by the CP removing module 19002;

an FFT module 19004, configured to perform FFT processing on a signal processed by the time domain DAGC module 19003;

a demodulating module 19005, configured to demodulate a signal processed by the FFT module 19004; and

a decoding module 19006, configured to decode a signal processed by the demodulating module 19005 to obtain the information that the network side needs to send to the second terminal 19.

Exemplarily,

the shared signal is obtained by the first terminal after performing time domain sampling processing, CP removal and time domain DAGC processing in turn on the signal received by the first terminal from the network side; the shared information further includes a DAGC factor of the time domain DAGC processing performed by the first terminal on the signal received by the first terminal from the network side; and

the obtaining unit 1903 may include:

a time domain sampling processing module 19001, configured to perform time domain sampling processing on the signal received by the second receiving unit from the network side;

a CP removing module 19002, configured to perform cyclic prefix (CP) removal processing on a signal processed by the time domain sampling processing module 19001;

a time domain DAGC module 19003, configured to perform DAGC compensation processing on the shared signal according to the DAGC factor of the time domain DAGC processing performed on the signal received by the first terminal from the network side, and perform time domain DAGC processing on a signal processed by the CP removing module 19002;

an FFT module 19004, configured to perform FFT processing on the shared signal and a signal processed by the time domain DAGC module 19003;

a demodulating module 19005, configured to demodulate a signal processed by the FFT module 19004; and

a decoding module 19006, configured to decode a signal processed by the demodulating module 19005 to obtain the information that the network side needs to send to the second terminal 19.

Exemplarily,

the shared signal is obtained by the first terminal after performing time domain sampling processing, CP removal, time domain DAGC, FFT and removal of information carried on a frequency domain resource of the first terminal in turn on the signal received by the first terminal from the network side; the shared information further includes a DAGC factor of the time domain DAGC processing performed by the first terminal on the signal received by the first terminal from the network side and a serial number of a frequency domain resource corresponding to the shared signal; and

the obtaining unit 1903 may include:

a time domain sampling processing module 19001, configured to perform time domain sampling processing on the signal received by the second receiving unit 1902 from the network side;

a CP removing module 19002, configured to perform cyclic prefix (CP) removal processing on a signal processed by the time domain sampling processing module 19001;

a time domain DAGC module 19003, configured to perform DAGC compensation processing on the shared signal according to the DAGC factor of the time domain DAGC processing performed on the signal received by the first terminal from the network side, and perform time domain DAGC processing on a signal processed by the CP removing module 19002;

an FFT module 19004, configured to perform FFT processing on a signal processed by the time domain DAGC module 18003;

a demodulating module 19005, configured to demodulate the signal processed by the FFT module 19004 according to the serial number of the frequency domain resource corresponding to the shared signal; and

a decoding module 19006, configured to decode a signal processed by the demodulating module 19005 to obtain the information that the network side needs to send to the second terminal 19.

Exemplarily,

the shared signal is obtained by the first terminal after performing time domain sampling processing, CP removal, time domain DAGC and FFT in turn on the signal received by the first terminal from the network side; the shared information further includes a DAGC factor of the time domain DAGC processing performed by the first terminal on the signal received by the first terminal from the network side; and

the obtaining unit 1903 further includes:

a time domain sampling processing module 19001, configured to perform time domain sampling processing on the signal received by the second receiving unit 1902 from the network side;

a CP removing module 19002, configured to perform cyclic prefix (CP) removal processing on a signal processed by the time domain sampling processing module 19001;

a time domain DAGC module 19003, configured to perform DAGC compensation processing on the shared signal according to the DAGC factor of the time domain DAGC processing performed on the signal received by the first terminal from the network side, and perform time domain DAGC processing on a signal processed by the CP removing module 19002;

an FFT module 19004, configured to perform FFT processing on a signal processed by the time domain DAGC module 19003;

a demodulating module 19005, configured to demodulate a signal processed by the FFT module 19004 according to a serial number of a frequency domain resource allocated by a system and corresponding to the second terminal 19; and

a decoding module 19006, configured to decode a signal processed by the demodulating module 19005 to obtain the information that the network side needs to send to the second terminal.

Exemplarily, the second terminal 19 may further include:

a sending unit 1904, configured to send identity information of the second terminal 19 to the first terminal, so that the first terminal performs time domain sampling processing, CP removal, time domain DAGC and FFT in turn on the signal received by the first terminal from the network side, obtains the shared signal according to the identity information of the second terminal 19 and obtains a signal quality of the shared signal; and does not send the shared information to the second terminal 19 when the signal quality of the shared signal is less than a preset threshold, or sends the shared information to the second terminal 19 when the signal quality of the shared signal is greater than or equal to the preset threshold, where the shared signal includes information carried on a frequency domain resource corresponding to the second terminal 19.

Exemplarily,

the shared information further includes a DAGC factor of the time domain DAGC processing performed by the first terminal on the signal received by the first terminal from the network side; and

the obtaining unit 1903 may include:

a time domain sampling processing module 19001, configured to perform time domain sampling processing on the signal received by the second receiving unit 1902 from the network side;

a CP removing module 19002, configured to perform cyclic prefix (CP) removal processing on a signal processed by the time domain sampling processing module 19001;

a time domain DAGC module 19003, configured to perform DAGC compensation processing on the shared signal according to the DAGC factor of the time domain DAGC processing performed on the signal received by the first terminal from the network side, and perform time domain DAGC processing on a signal processed by the CP removing module 19002;

an FFT module 19004, configured to perform FFT processing on a signal processed by the time domain DAGC module 19003;

a demodulating module 19005, configured to demodulate a signal processed by the FFT module 19004 according to information carried on a frequency domain resource corresponding to the shared signal; and

a decoding module 19006, configured to decode a signal processed by the demodulating module 19005 to obtain the information that the network side needs to send to the second terminal 19.

The sending unit 1904 is configured to send identity information of the second terminal 19 to the first terminal, so that the first terminal performs time domain sampling processing, CP removal, time domain DAGC and FFT in turn on the signal received by the first terminal from the network side, obtains the shared signal according to the identity information of the second terminal 19 and obtains a signal quality of the shared signal; and does not send the shared information to the second terminal 19 when the signal quality of the shared signal is less than a preset threshold, or sends the shared information to the second terminal 19 when the signal quality of the shared signal is greater than or equal to the preset threshold, where the shared signal includes information carried on a frequency domain resource corresponding to the second terminal 19.

According to an inter-terminal coordinated communication device provided by the embodiment of the present patent application, the second terminal 19 receives the shared information sent by the first terminal, so that the second terminal 19 obtains the information that the network side needs to send to the second terminal 19 according to the shared information and the signal received by the second terminal 19 from the network side. The shared information includes the shared signal. Problems in the prior art that the network side needs to jointly process a signal sent by the network side which increases a complexity of information processing of the network side, and that a terminal needs to completely demodulate information of other terminals which increases a processing load of the terminal are overcome.

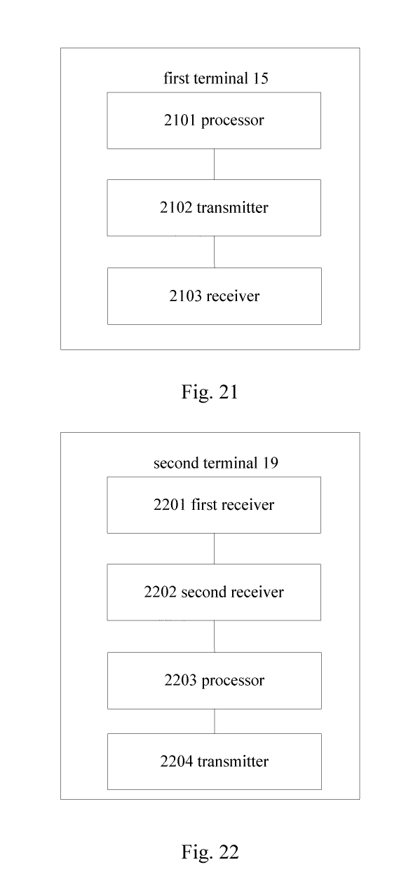

FIG. 21 is an apparatus schematic diagram of a first terminal provided by an embodiment of the present patent application. Referring to the figure, the first terminal 15 includes:

a processor 2101, configured to obtain a shared signal according to a signal received by the first terminal 15 from a network side, and transmit the shared signal to a sending unit 2102; and

a transmitter 2102, configured to send shared information to a second terminal, for enabling the second terminal to obtain information that the network side needs to send to the second terminal according to the shared information and a signal received by the second terminal from the network side, where the shared information includes the shared signal.

Exemplarily, the processor 2101 may be further configured to:

perform time domain sampling processing on the signal received by the first terminal 15 from the network side to obtain the shared signal.

Exemplarily, the processor 2101 may be further configured to:

perform time domain sampling processing, cyclic prefix (CP) removal and time domain digital automatic gain control (DAGC) processing in turn on the signal received by the first terminal 15 from the network side to obtain the shared signal; and

the shared information further includes a DAGC factor of the time domain DAGC processing performed by the first terminal 15 on the signal received by the first terminal 15 from the network side and a serial number of a frequency domain resource corresponding to the shared signal.

Exemplarily, the processor 2101 may be further configured to:

perform time domain sampling processing, CP removal, time domain DAGC processing, fast Fourier transform (FFT) and removal of information carried on a frequency domain resource of the first terminal 15 in turn on the signal received by the first terminal 15 from the network side to obtain the shared signal; and

the shared information further includes a DAGC factor of the time domain DAGC processing performed by the first terminal 15 on the signal received by the first terminal 15 from the network side and a serial number of a frequency domain resource corresponding to the shared signal.

Exemplarily, the processor 2101 may be further configured to:

perform time domain sampling processing, CP removal, time domain DAGC processing and fast Fourier transform (FFT) processing in turn on the signal received by the first terminal 15 from the network side to obtain the shared signal; and

the shared information further includes a DAGC factor of the time domain DAGC processing performed by the first terminal on the signal received by the first terminal from the network side.

Exemplarily, the first terminal 15 may further include:

a receiver 2103, configured to receive identity information of the second terminal; and

the processor 2101 may be further configured to:

obtain the shared signal according to the identity information of the second terminal, where the shared signal includes information carried on a frequency domain resource corresponding to the second terminal.

Exemplarily,

the processor 2101 may be further configured to obtain a signal quality of the shared signal; and

the transmitter 2102 may be further configured to enable the first terminal 15 not to send the shared information to the second terminal, when the signal quality of the shared signal is less than a preset threshold;

or, enable the first terminal 15 to send the shared information to the second terminal, when the signal quality of the shared signal is greater than or equal to the preset threshold.

According to an inter-terminal coordinated communication system provided by the embodiment of the present patent application, the first terminal 15 obtains the shared signal according to the signal received by the first terminal 15 from the network side. The first terminal 15 sends the shared information to the second terminal, for enabling the second terminal to obtain the information that the network side needs to send to the second terminal according to the shared information and the signal received by the second terminal from the network side. The shared information includes the shared signal. Problems in the prior art that the network side needs to jointly process a signal sent by the network side which increases a complexity of information processing of the network side, and that a terminal needs to completely demodulate information of other terminals which increases a processing load of the terminal are overcome.

FIG. 22 is an apparatus schematic diagram of a second terminal provided by an embodiment of the present patent application. Referring to the figure, the second terminal 19 includes:

a first receiver 2201, configured to receive shared information sent by a first terminal and transmit the shared information to a processor 2203, where the shared information includes a shared signal obtained by the first terminal according to a signal received by the first terminal from a network side;

a second receiver 2202, configured to receive a signal from the network side and transmit the signal to the obtaining unit 2203; and

the processor 2203, configured to obtain information that the network side needs to send to the second terminal 19 according to the shared information and the signal received by the second receiving unit 2202 from the network side.

Exemplarily, the information that the network side needs to send to the second terminal 19 includes information of the second terminal 19 in the shared signal and information of the second terminal 19 received by the second terminal 19.

Exemplarily,

the shared signal is obtained by the first terminal after performing time domain sampling processing on the signal received by the first terminal from the network side; and

the processor 2203 may be further configured to:

perform CP removal, time domain DAGC processing, fast Fourier transform FFT, demodulating and decoding in turn on the shared signal to obtain information of the second terminal 19 in the shared signal; perform time domain sampling processing, CP removal, time domain DAGC processing, FFT, demodulating and decoding in turn on the signal received by the second terminal from the network side to obtain information of the second terminal 19 received by the second terminal 19.

Exemplarily,

the shared signal is obtained by the first terminal after performing time domain sampling processing, CP removal and time domain DAGC processing in turn on the signal received by the first terminal from the network side; the shared information further includes a DAGC factor of the time domain DAGC processing performed by the first terminal on the signal received by the first terminal from the network side; and

the processor 2203 may be further configured to:

perform DAGC compensation processing on the shared signal according to the DAGC factor of the time domain DAGC processing performed on the signal received by the first terminal from the network side, and perform FFT, demodulating and decoding in turn on the processed shared signal to obtain information of the second terminal 19 in the shared signal; perform time domain sampling processing, CP removal, time domain DAGC, FFT, demodulating and decoding in turn on the signal received by the second terminal 19 from the network side to obtain information of the second terminal 19 received by the second terminal 19.

Exemplarily,

the shared signal is obtained by the first terminal after performing time domain sampling processing, CP removal, time domain DAGC, and FFT and removal of information carried on a frequency domain resource of the first terminal in turn on the signal received by the first terminal from the network side; the shared information further includes a DAGC factor of the time domain DAGC processing performed by the first terminal on the signal received by the first terminal from the network side and a serial number of a frequency domain resource corresponding to the shared signal; and

the processor 2203 may be further configured to:

perform DAGC compensation processing on the shared signal according to the DAGC factor of the time domain DAGC processing performed on the signal received by the first terminal from the network side, and perform demodulating and decoding in turn on the processed shared signal according to the serial number of the frequency domain resource corresponding to the shared signal to obtain information of the second terminal in the shared signal; perform time domain sampling processing, CP removal, time domain DAGC, FFT, demodulating and decoding in turn on the signal received by the second terminal 19 from the network side to obtain information of the second terminal received by the second terminal 19.

Exemplarily,

the shared signal is obtained by the first terminal after performing time domain sampling processing, CP removal, time domain DAGC and FFT in turn on the signal received by the first terminal from the network side; the shared information further includes a DAGC factor of the time domain DAGC processing performed by the first terminal on the signal received by the first terminal from the network side; and

the processor 2203 may be further configured to:

obtain information carried on a frequency domain resource of the second terminal 19 according to a serial number of the frequency domain resource allocated by a system and corresponding to the second terminal 19, perform DAGC compensation processing on the information carried on the frequency domain resource of the second terminal 19 according to the DAGC factor of the time domain DAGC processing performed on the signal received by the first terminal from the network side, perform demodulating and decoding in turn on the processed information carried on the frequency domain resource of the second terminal 19 to obtain information of the second terminal 19 in the shared signal; perform time domain sampling processing, CP removal, time domain DAGC, FFT, demodulating and decoding in turn on the signal received by the second terminal 19 from the network side to obtain information of the second terminal 19 received by the second terminal 19.

Exemplarily, the second terminal 19 may further include:

a transmitter 2204, configured to send identity information of the second terminal 19 to the first terminal, so that the first terminal performs time domain sampling processing, CP removal, time domain DAGC and FFT in turn on the signal received by the first terminal from the network side, obtains the shared signal according to the identity information of the second terminal 19 and obtains a signal quality of the shared signal; and does not send the shared information to the second terminal 19 when the signal quality of the shared signal is less than a preset threshold, or sends the shared information to the second terminal 19 when the signal quality of the shared signal is greater than or equal to the preset threshold, where the shared signal includes information carried on a frequency domain resource corresponding to the second terminal 19.

Exemplarily,

the shared information further includes a DAGC factor of the time domain DAGC processing performed by the first terminal on the signal received by the first terminal from the network side; and

the processor 2203 may be further configured to:

perform DAGC compensation processing on the shared signal according to the DAGC factor of the time domain DAGC processing performed on the signal received by the first terminal from the network side, perform demodulating and decoding in turn on the processed shared signal to obtain information of the second terminal 19 in the shared signal; perform time domain sampling processing, CP removal, time domain DAGC, FFT, demodulating and decoding in turn on the signal received by the second terminal 19 from the network side to obtain information of the second terminal 19 received by the second terminal 19.

According to an inter-terminal coordinated communication system provided by the embodiment of the present patent application, the second terminal 19 receives the shared information sent by the first terminal, so that the second terminal 19 obtains the information that the network side needs to send to the second terminal 19 according to the shared information and the signal received by the second terminal 19 from the network side. The shared information includes the shared signal. Problems in the prior art that the network side needs to jointly process a signal sent by the network side which increases a complexity of information processing of the network side, and that a terminal needs to completely demodulate information of other terminals which increases a processing load of the terminal are overcome.

Those of ordinary skill in the art may understand that all or a part of the steps in the above-mentioned method embodiments may be implemented by a program instructing corresponding hardware, the foregoing program may be stored in a computer readable storage medium, and when being executed, the program may execute the steps of the above-mentioned method embodiments; the foregoing storage medium includes various kinds of medium that may store program codes, such as ROM, RAM, a magnetic disk or an optical disk, etc.

The foregoing descriptions are merely specific embodiments of the present patent application, rather than limiting the protection scope of the present patent application. Any change or substitution that is readily conceived for any one skilled in the art within the technical scope disclosed by the patent application shall fall into the protection scope of the patent application. Therefore, the protection scope of the present patent application shall be defined by the claims.

What is claimed is:

1. A method for inter-terminal coordinated communication, comprising:
obtaining, by a first terminal, a shared signal according to a signal received by the first terminal from a network side; and
sending, by the first terminal, shared information to a second terminal, for enabling the second terminal to obtain information that the network side needs to send to the second terminal according to the shared information and a signal received by the second terminal from the network side, wherein the shared information comprises the shared signal.

2. The method according to claim 1, wherein the obtaining, by the first terminal, the shared signal according to the signal received by the first terminal from the network side, comprises:
performing, by the first terminal, time domain sampling processing on the signal received by the first terminal from the network side to obtain the shared signal.

3. The method for inter-terminal coordinated communication according to claim 1, wherein the obtaining, by the first terminal, the shared signal according to the signal received by the first terminal from the network side, comprises:
performing, by the first terminal, time domain sampling processing, cyclic prefix (CP) removal and time domain digital automatic gain control (DAGC) processing in turn on the signal received by the first terminal from the network side to obtain the shared signal; and
the shared information further comprises a DAGC factor of the time domain DAGC processing performed by the first terminal on the signal received by the first terminal from the network side.

4. The method according to claim 1, wherein the obtaining, by the first terminal, the shared signal according to the signal received by the first terminal from the network side, comprises:
performing, by the first terminal, time domain sampling processing, CP removal, time domain DAGC, fast Fourier transform (FFT) and removal of information carried on a frequency domain resource of the first terminal in turn on the signal received by the first terminal from the network side to obtain the shared signal; and
the shared information further comprises a DAGC factor of the time domain DAGC processing performed by the first terminal on the signal received by the first terminal from the network side and a serial number of a frequency domain resource corresponding to the shared signal.

5. The method according to claim 1, wherein the obtaining, by the first terminal, the shared signal according to the signal received by the first terminal from the network side, comprises:
performing, by the first terminal, time domain sampling processing, CP removal, time domain DAGC and FFT processing in turn on the signal received by the first terminal from the network side to obtain the shared signal; and
the shared information further comprises a DAGC factor of the time domain DAGC processing performed by the first terminal on the signal received by the first terminal from the network side.

6. The method according to claim 5, wherein the method further comprises:
receiving, by the first terminal, identity information of the second terminal;
and, the obtaining, by the first terminal, the shared signal according to the signal received by the first terminal from the network side, further comprises:
obtaining, by the first terminal, the shared signal according to the identity information of the second terminal, wherein the shared signal comprises information carried on a frequency domain resource corresponding to the second terminal.

7. A method for inter-terminal coordinated communication, comprising:
receiving, by a second terminal, shared information sent by a first terminal, wherein the shared information comprises a shared signal obtained by the first terminal according to a signal received by the first terminal from a network side; and
obtaining, by the second terminal, information that the network side needs to send to the second terminal according to the shared information and a signal received by the second terminal from the network side.

8. The method according to claim 7, wherein the shared signal is obtained by the first terminal after performing time domain sampling processing on the signal received by the first terminal from the network side;
and, the obtaining, by the second terminal, the information that the network side needs to send to the second terminal according to the shared information and the signal received by the second terminal from the network side, comprises:
performing, by the second terminal, cyclic prefix (CP) removal, time domain digital automatic gain control (DAGC), fast Fourier transform (FFT), demodulating and decoding in turn on the shared signal to obtain information of the second terminal in the shared signal; and
performing, by the second terminal, time domain sampling processing, CP removal, time domain DAGC, FFT, demodulating and decoding in turn on the signal received by the second terminal from the network side to obtain information of the second terminal received by the second terminal.

9. The method according to claim 7, wherein the shared signal is obtained by the first terminal after performing time domain sampling processing, CP removal and time domain DAGC processing in turn on the signal received by the first terminal from the network side;
and, the shared information further comprises a DAGC factor of the time domain DAGC processing performed by the first terminal on the signal received by the first terminal from the network side;
and, the obtaining, by the second terminal, the information that the network side needs to send to the second terminal according to the shared information and the signal received by the second terminal from the network side, comprises:
performing, by the second terminal, DAGC compensation processing on the shared signal according to the DAGC factor of the time domain DAGC processing performed on the signal received by the first terminal from the network side, and performing FFT, demodulating and decoding in turn on the processed shared signal to obtain information of the second terminal in the shared signal; and
performing, by the second terminal, time domain sampling processing, CP removal, time domain DAGC, FFT, demodulating and decoding in turn on the signal received by the second terminal from the network side to obtain information of the second terminal received by the second terminal.

10. The method according to claim 7, wherein the shared signal is obtained by the first terminal after performing time domain sampling processing, CP removal, time domain DAGC, FFT and removal of information carried on a frequency domain resource of the first terminal in turn on the signal received by the first terminal from the network side;
and, the shared information further comprises a DAGC factor of the time domain DAGC processing performed by the first terminal on the signal received by the first terminal from the network side and a serial number of a frequency domain resource corresponding to the shared signal;
and, the obtaining, by the second terminal, the information that the network side needs to send to the second terminal according to the shared information and the signal received by the second terminal from the network side, comprises:
performing, by the second terminal, DAGC compensation processing on the shared signal according to the DAGC factor of the time domain DAGC processing performed on the signal received by the first terminal from the network side, and performing demodulating and decoding in turn on the processed shared signal according to the serial number of the frequency domain resource corresponding to the shared signal to obtain information of the second terminal in the shared signal; and
performing, by the second terminal, time domain sampling processing, CP removal, time domain DAGC, FFT, demodulating and decoding in turn on the signal received by the second terminal from the network side to obtain information of the second terminal received by the second terminal.

11. The method according to claim 7, wherein the shared signal is obtained by the first terminal after performing time domain sampling processing, CP removal, time domain DAGC and FFT in turn on the signal received by the first terminal from the network side;
and, the shared information further comprises a DAGC factor of the time domain DAGC processing performed by the first terminal on the signal received by the first terminal from the network side;
and, the obtaining, by the second terminal, the information that the network side needs to send to the second terminal according to the shared information and the signal received by the second terminal from the network side, comprises:
obtaining, by the second terminal, information carried on a frequency domain resource of the second terminal according to a serial number of the frequency domain resource corresponding to the second terminal and allocated by a system, performing DAGC compensation processing on the information carried on the frequency domain resource of the second terminal according to the DAGC factor of the time domain DAGC processing performed on the signal received by the first terminal from the network side, and performing demodulating and decoding in turn on the processed information carried on the frequency domain resource of the second terminal to obtain information of the second terminal in the shared signal; and
performing, by the second terminal, time domain sampling processing, CP removal, time domain DAGC, FFT, demodulating and decoding in turn on the signal received by the second terminal from the network side to obtain information of the second terminal received by the second terminal.

12. The method according to claim 7, wherein the method further comprises:
sending, by the second terminal, identity information of the second terminal to the first terminal, so that the first terminal performs time domain sampling processing, CP removal, time domain DAGC and FFT in turn on the signal received by the first terminal from the network side, obtains the shared signal according to the identity information of the second terminal and obtains a signal quality of the shared signal; and does not send the shared information to the second terminal when the signal quality of the shared signal is less than a preset threshold, or sends the shared information to the second terminal when the signal quality of the shared signal is greater than or equal to the preset threshold, wherein the shared signal comprises information carried on a frequency domain resource corresponding to the second terminal;
the shared information further comprises a DAGC factor of time domain DAGC processing performed by the first terminal on the signal received by the first terminal from the network side; and
the obtaining, by the second terminal, the information that the network side needs to send to the second terminal according to the shared information and the signal received by the second terminal from the network side, comprises:
performing, by the second terminal, DAGC compensation processing on the shared signal according to the DAGC factor of the time domain DAGC processing performed on the signal received by the first terminal from the network side, and performing demodulating and decoding in turn on the processed shared signal to obtain information of the second terminal in the shared signal; and
performing, by the second terminal, time domain sampling processing, CP removal, time domain DAGC, FFT, demodulating and decoding in turn on the signal received by the second terminal from the network side to obtain information of the second terminal received by the second terminal.

13. A first terminal, comprising:
a processor, configured to obtain a shared signal according to a signal received by the first terminal from a network side; and
a transmitter, configured to send shared information to a second terminal, for enabling the second terminal to obtain information that the network side needs to send to the second terminal according to the shared information and a signal received by the second terminal from the network side, wherein the shared information comprises the shared signal.

14. The first terminal according to claim 13 wherein the processor is configured to perform time domain sampling processing on the signal received by the first terminal from the network side to obtain the shared signal.

15. The first terminal according to claim 13, wherein the processor is configured to perform time domain sampling processing on the signal received by the first terminal from the network side;
remove a cyclic prefix (CP) from a signal after the time domain sampling processing; and
perform time domain digital automatic gain control (DAGC) processing on a signal after CP removing to obtain the shared signal; and
the shared information further comprises a DAGC factor of the time domain DAGC processing performed by the first terminal on the signal received by the first terminal from the network side.

16. The first terminal according to claim 13, wherein the processor is configured to perform time domain sampling processing on the signal received by the first terminal from the network side;
remove a CP from a signal after the time domain sampling processing;
perform time domain DAGC processing on a signal after CP removing; and
perform fast Fourier transform (FFT) and removal of information carried on a frequency domain resource of the first terminal on a signal after the time domain DAGC processing to obtain the shared signal; and
the shared information further comprises a DAGC factor of the time domain DAGC processing performed by the first terminal on the signal received by the first terminal from the network side and a serial number of a frequency domain resource corresponding to the shared signal.

17. A second terminal, comprising:
a receiver, configured to receive shared information sent by a first terminal, wherein the shared information comprises a shared signal obtained by the first terminal according to a signal received by the first terminal from a network side, and receive a signal from the network side; and
a processor, configured to obtain information that the network side needs to send to the second terminal according to the shared information and the signal received from the network side.

18. The second terminal according to claim 17, wherein the shared signal is obtained by the first terminal after performing time domain sampling processing on the signal received by the first terminal from the network side, and the processor is configured to perform time domain sampling processing on the signal received from the network side;
perform cyclic prefix (CP) removal processing on the shared signal and a signal after the time domain sampling processing and received from the network side;
perform time domain digital automatic gain control (DAGC) processing on a signal after CP removing;
perform fast Fourier transform (FFT) processing on a signal afrer the time domain DAGC processing;
demodulate a signal after the FFT processing; and
decode a signal after demodulating to obtain the information that the network side needs to send to the second terminal.

19. The second terminal according to claim 17, wherein the shared signal is obtained by the first terminal after performing time domain sampling processing, CP removal and time domain DAGC processing in turn on the signal received by the first terminal from the network side; the shared information further comprises a DAGC factor of the time domain DAGC processing performed by the first terminal on the signal received by the first terminal from the network side; and
the processor is configured to perform time domain sampling processing on the signal received from the network side;
perform CP removal processing on a signal after the time domain sampling processing;
perform DAGC compensation processing on the shared signal according to the DAGC factor of the time domain DAGC processing performed on the signal received by the first terminal from the network side, and perform time domain DAGC processing on a signal after CP removing;
perform FFT processing on the shared signal and a signal after the time domain DAGC;
demodulate a signal after the FFT processing; and
decode a signal after demodulating to obtain the information that the network side needs to send to the second terminal.

20. The second terminal according to claim 17, wherein the shared signal is obtained by the first terminal after performing time domain sampling processing, CP removal, time domain DAGC, FFT and removal of information carried on a frequency domain resource of the first terminal in turn on the signal received by the first terminal from the network side; the shared information further comprises a DAGC factor of the time domain DAGC processing performed by the first terminal on the signal received by the first terminal from the network side and a serial number of a frequency domain resource corresponding to the shared signal; and
the processor is configured to perform time domain sampling processing on the signal received from the network side;
perform CP removal processing on a signal after the time domain sampling processing;
perform DAGC compensation processing on the shared signal according to the DAGC factor of the time domain DAGC processing performed on the signal received by the first terminal from the network side, and perform time domain DAGC processing on a signal after CP removing;
perform FFT processing on a signal after the time domain DAGC processing;
demodulate a signal after the FFT processing according to the serial number of the frequency domain resource corresponding to the shared signal; and
decode a signal after demodulating to obtain the information that the network side needs to send to the second terminal.
